(19) United States
(12) Patent Application Publication
(10) Pub. No.: US 2024/0323755 A1
(43) Pub. Date: Sep. 26, 2024

(54) MANAGEMENT OF WIRELESS FRONTHAUL LINKS

(71) Applicant: QUALCOMM Incorporated, San Diego, CA (US)

(72) Inventors: Meilong Jiang, Westfield, NJ (US); Juergen Cezanne, Ocean Township, NJ (US); Ahmed Bedewy, Hillsborough, NJ (US); Ori Shental, Marlboro, NJ (US); Ashwin Sampath, Skillman, NJ (US); Ozge Koymen, Princeton, NJ (US); Junyi Li, Fairless Hills, PA (US)

(21) Appl. No.: 18/189,061

(22) Filed: Mar. 23, 2023

(51) Int. Cl. H04W 28/06; H04L 5/00; H04W 72/52

(52) U.S. Cl. CPC H04W 28/06; H04L 5/0098; H04W 72/52

(57) ABSTRACT

Methods, systems, and devices for wireless communication are described. An FNC may be implemented to manage operations of a wireless fronthaul network. The FNC may monitor one or more network conditions and parameters of a network, which may include a fronthaul network and a radio access network. The fronthaul network may include at least one DU that supports wireless communications with a plurality of RUs via a plurality of fronthaul communication links, and the radio access network may include the plurality of RUs supporting communications for a plurality of wireless devices. The FNC may output, based on the one or more network conditions and the parameters, one or more fronthaul operation parameters for the at least one DU to support wireless communication for at least one RU of the plurality of RUs via one or more respective communication links of the plurality of communication links.

### FIELD OF TECHNOLOGY

The following relates to wireless communication, including management of wireless fronthaul links.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support management of wireless fronthaul links. For example, the described techniques provide for a fronthaul network controller (FNC) to manage operations of a network that may include a wireless fronthaul network. The FNC may monitor one or more network conditions and parameters of a network, which may include a fronthaul network, which may be wireless, and a radio access network. The fronthaul network may include at least one distributed unit (DU) that supports wireless communications with multiple radio units (RUS) via multiple (e.g., respective) fronthaul communication links, and the radio access network may include the multiple RUs supporting communications for one or more wireless devices, such as user equipment (UE). The FNC may determine, generate, or otherwise obtain one or more fronthaul operation parameters based on the network conditions and parameters and output the one or more fronthaul operation parameters for the to support wireless communications for the multiple RUs via one or more respective communication links.

An apparatus for wireless communications at a network entity is described. The apparatus may include a processor, memory coupled with the processor, and instructions stored in the memory. The instructions may be executable by the processor to cause the apparatus to monitor one or more network conditions and parameters of a network, the network including a fronthaul network and a radio access network, where the fronthaul network includes at least one DU supporting wireless communications for a set of multiple RUs via a set of multiple fronthaul communication links, and the radio access network includes the set of multiple RUs supporting communications for a set of multiple wireless devices and outputting, based at least in part on the one or more network conditions and the parameters, one or more fronthaul operation parameters for the at least one DU to support wireless communications for at least one RU of the set of multiple RUs via one or more respective fronthaul communication links of the set of multiple fronthaul communication links.

A method for wireless communications at a network entity is described. The method may include monitoring one or more network conditions and parameters of a network, the network including a fronthaul network and a radio access network, where the fronthaul network includes at least one DU supporting wireless communications for a set of multiple RUs via a set of multiple fronthaul communication links, and the radio access network includes the set of multiple RUs supporting communications for a set of multiple wireless devices and outputting, based on the one or more network conditions and the parameters, one or more fronthaul operation parameters for the at least one DU to support wireless communications for at least one RU of the set of multiple RUs via one or more respective fronthaul communication links of the set of multiple fronthaul communication links.

Another apparatus for wireless communications at a network entity is described. The apparatus may include means for monitoring one or more network conditions and parameters of a network, the network including a fronthaul network and a radio access network, where the fronthaul network includes at least one DU supporting wireless communications for a set of multiple RUs via a set of multiple fronthaul communication links, and the radio access network includes the set of multiple RUs supporting communications for a set of multiple wireless devices and means for outputting, based on the one or more network conditions and the parameters, one or more fronthaul operation parameters for the at least one DU to support wireless communications for at least one RU of the set of multiple RUs via one or more respective fronthaul communication links of the set of multiple fronthaul communication links.

A non-transitory computer-readable medium storing code for wireless communications at a network entity is described. The code may include instructions executable by a processor to monitor one or more network conditions and parameters of a network, the network including a fronthaul network and a radio access network, where the fronthaul network includes at least one DU supporting wireless communications for a set of multiple RUs via a set of multiple fronthaul communication links, and the radio access network includes the set of multiple RUs supporting communications for a set of multiple wireless devices and outputting, based at least in part on the one or more network conditions and the parameters, one or more fronthaul operation parameters for the at least one DU to support wireless communications for at least one RU of the set of multiple RUs via one or more respective fronthaul communication links of the set of multiple fronthaul communication links.

Some examples of the method, apparatuses, and non-transitory computer-readable medium described herein may further include operations, features, means, or instructions for detecting that a change in the one or more network conditions and the parameters of the network exceeds a threshold value, where outputting the one or more fronthaul operation parameters may be based on detecting that the change exceeds the threshold value.

Some examples of the method, apparatuses, and non-transitory computer-readable medium described herein may further include operations, features, means, or instructions for obtaining an indication of available resources at the at least one DU, where the one or more fronthaul operation parameters may be based on the available resources.

In some examples of the method, apparatuses, and non-transitory computer-readable medium described herein, monitoring the one or more network conditions and the parameters may include operations, features, means, or instructions for monitoring a traffic load of the radio access network, a delay budget associated with the set of multiple wireless devices supported by the set of multiple RUs, an activation status of the at least one RU, or a combination thereof.

Some examples of the method, apparatuses, and non-transitory computer-readable medium described herein may further include operations, features, means, or instructions for detecting that a change in the traffic load exceeds a threshold value, where the one or more fronthaul operation parameters may be based on the change in the traffic load exceeding the threshold value, and the one or more fronthaul operation parameters include a quantity of antenna panels per fronthaul communication link of the set of multiple fronthaul communication links, a transmit power for each antenna panel, a quantity of resources assigned to each fronthaul communication link of the set of multiple fronthaul communication links, or any combination thereof.

Some examples of the method, apparatuses, and non-transitory computer-readable medium described herein may further include operations, features, means, or instructions for detecting that an increase in the traffic load exceeds a threshold value and outputting, based on detecting that the increase in the traffic load exceeds the threshold value, a message indicating the at least one DU to activate one or more carrier components associated with the set of multiple fronthaul communication links, one or more serving antenna panels associated with the set of multiple fronthaul communication links, or a combination thereof.

In some examples of the method, apparatuses, and non-transitory computer-readable medium described herein, outputting the one or more fronthaul operation parameters may include operations, features, means, or instructions for outputting a multiplexing mode for the at least one DU, where the multiplexing mode may be based on the one or more network conditions and the parameters of the network.

Some examples of the method, apparatuses, and non-transitory computer-readable medium described herein may further include operations, features, means, or instructions for obtaining positioning information associated with the set of multiple RUs, where the one or more network conditions and the parameters includes the positioning information of the set of multiple RUs and selecting the multiplexing mode based on the positioning information.

In some examples of the method, apparatuses, and non-transitory computer-readable medium described herein, the multiplexing mode includes a spatial division multiplexing mode, a frequency division multiplexing mode, a time division multiplexing mode, or a combination thereof.

In some examples of the method, apparatuses, and non-transitory computer-readable medium described herein, monitoring the one or more network conditions and the parameters may include operations, features, means, or instructions for monitoring for capability and resource information of the at least one DU, the set of multiple RUS, or any combination thereof.

In some examples of the method, apparatuses, and non-transitory computer-readable medium described herein, the capability and resource information includes a quantity of antenna panels, a power value associated with each antenna panel, a quantity of supported layers, an indication of available beams and beam bandwidths, or any combination thereof.

In some examples of the method, apparatuses, and non-transitory computer-readable medium described herein, the one or more fronthaul operation parameters include panel assignments for the at least one RU, beamforming weights for the at least one RU, or any combination thereof.

In some examples of the method, apparatuses, and non-transitory computer-readable medium described herein, the one or more fronthaul operation parameters include Layer 1 parameters of the fronthaul network, Layer 2 parameters of the fronthaul network, or any combination thereof.

In some examples of the method, apparatuses, and non-transitory computer-readable medium described herein, the network entity includes an FNC associated with a near-real time radio access network (RAN) intelligent controller or a non-real time RAN intelligent controller.

An apparatus for wireless communication at a DU is described. The apparatus may include a processor, memory coupled with the processor, and instructions stored in the memory. The instructions may be executable by the processor to cause the apparatus to output one or more network conditions and parameters of a network, the network including a fronthaul network and a radio access network, where the fronthaul network includes at least the DU that supports wireless communications for a set of multiple RUs via a set of multiple fronthaul communication links, and the radio access network includes the set of multiple RUs supporting communications for a set of multiple wireless devices and obtaining, based at least in part on outputting the one or more network conditions and the parameters, one or more fronthaul operation parameters to support wireless communications for at least one RU of the set of multiple RUs via one or more respective fronthaul communication links of the set of multiple fronthaul communication links.

A method for wireless communication at a DU is described. The method may include outputting one or more network conditions and parameters of a network, the network including a fronthaul network and a radio access network, where the fronthaul network includes at least the DU that supports wireless communications for a set of multiple RUs via a set of multiple fronthaul communication links, and the radio access network includes the set of multiple RUs supporting communications for a set of multiple wireless devices and obtaining, based on outputting the one or more network conditions and the parameters, one or more fronthaul operation parameters to support wireless communications for at least one RU of the set of multiple RUs via one or more respective fronthaul communication links of the set of multiple fronthaul communication links.

Another apparatus for wireless communication at a DU is described. The apparatus may include means for outputting one or more network conditions and parameters of a network, the network including a fronthaul network and a radio access network, where the fronthaul network includes at least the DU that supports wireless communications for a set of multiple RUs via a set of multiple fronthaul communication links, and the radio access network includes the set of multiple RUs supporting communications for a set of multiple wireless devices and means for obtaining, based on outputting the one or more network conditions and the parameters, one or more fronthaul operation parameters to support wireless communications for at least one RU of the set of multiple RUs via one or more respective fronthaul communication links of the set of multiple fronthaul communication links.

A non-transitory computer-readable medium storing code for wireless communication at a DU is described. The code may include instructions executable by a processor to output one or more network conditions and parameters of a network, the network including a fronthaul network and a radio access network, where the fronthaul network includes at least the DU that supports wireless communications for a set of multiple RUs via a set of multiple fronthaul communication links, and the radio access network includes the set of multiple RUs supporting communications for a set of multiple wireless devices and obtaining, based at least in part on outputting the one or more network conditions and the parameters, one or more fronthaul operation parameters to support wireless communications for at least one RU of the set of multiple RUs via one or more respective fronthaul communication links of the set of multiple fronthaul communication links.

In some examples of the method, apparatuses, and non-transitory computer-readable medium described herein, outputting, to the at least one RU, at least a portion of the one or more fronthaul operation parameters based on obtaining the one or more fronthaul operation parameters.

In some examples of the method, apparatuses, and non-transitory computer-readable medium described herein, outputting the one or more network conditions and the parameters may include operations, features, means, or instructions for outputting an indication of available resources at the DU, where obtaining the one or more fronthaul operation parameters may be based on outputting the indication of the available resources.

In some examples of the method, apparatuses, and non-transitory computer-readable medium described herein, the one or more network conditions and the parameters include a traffic load of the radio access network, a delay budget associated with the set of multiple wireless devices supported by the set of multiple RUs, an activation status of the at least one RU, or a combination thereof.

In some examples of the method, apparatuses, and non-transitory computer-readable medium described herein, the one or more fronthaul operation parameters include a quantity of antenna panels per fronthaul communication link of the set of multiple fronthaul communication links, a transit power for each antenna panel, a quantity of resources assigned to each fronthaul communication link of the set of multiple fronthaul communication links, or any combination thereof, and obtaining the one or more fronthaul operation parameters may be based on a change in the traffic load exceeding a threshold value.

In some examples of the method, apparatuses, and non-transitory computer-readable medium described herein, obtaining, based on an increase in the traffic load exceeding a threshold value, a message indicating the DU to activate one or more carrier components associated with the set of multiple fronthaul communication links, one or more serving antenna panels associated with the set of multiple fronthaul communication links, or a combination thereof.

In some examples of the method, apparatuses, and non-transitory computer-readable medium described herein, obtaining, based on outputting the one or more network conditions and the parameters, a multiplexing mode for the DU.

Some examples of the method, apparatuses, and non-transitory computer-readable medium described herein may further include operations, features, means, or instructions for outputting positioning information associated with the set of multiple RUs, where multiplexing mode may be based on the positioning information and applying the multiplexing mode to the one or more respective fronthaul communication links of the set of multiple fronthaul communication links to support wireless communications with the at least one RU.

In some examples of the method, apparatuses, and non-transitory computer-readable medium described herein, the multiplexing mode includes a spatial division multiplexing mode, a frequency division multiplexing mode, a time division multiplexing mode, or a combination thereof.

In some examples of the method, apparatuses, and non-transitory computer-readable medium described herein, outputting the one or more network conditions and the parameters may include operations, features, means, or instructions for outputting capability and resource information of the DU, the set of multiple RUs, or any combination thereof.

In some examples of the method, apparatuses, and non-transitory computer-readable medium described herein, the capability and resource information includes a quantity of antenna panels, a power value associated with each antenna panel, a quantity of supported layers, an indication of available beams and beam bandwidths, or any combination thereof.

In some examples of the method, apparatuses, and non-transitory computer-readable medium described herein, the one or more fronthaul operation parameters include panel assignments for the at least one RU, beamforming weights for the at least one RU, or any combination thereof.

In some examples of the method, apparatuses, and non-transitory computer-readable medium described herein, the one or more fronthaul operation parameters include Layer 1 parameters of the fronthaul network, Layer 2 parameters of the fronthaul network, or any combination thereof.

### BRIEF DESCRIPTION OF THE DRAWINGS

FIG. 1 shows an example of a wireless communications system that supports management of wireless fronthaul links in accordance with one or more aspects of the present disclosure.

FIG. 2 shows an example of a network architecture that supports management of wireless fronthaul links in accordance with one or more aspects of the present disclosure.

FIG. 3 shows an example of a wireless communications system that supports management of wireless fronthaul links in accordance with one or more aspects of the present disclosure.

FIGS. 4A and 4B show examples of wireless communications systems that support management of wireless fronthaul links in accordance with one or more aspects of the present disclosure.

FIG. 5 shows an example of a process flow that supports management of wireless fronthaul links in accordance with one or more aspects of the present disclosure.

FIGS. 6 and 7 show block diagrams of devices that support management of wireless fronthaul links in accordance with one or more aspects of the present disclosure.

FIG. 8 shows a block diagram of a communications manager that supports management of wireless fronthaul links in accordance with one or more aspects of the present disclosure.

FIG. 9 shows a diagram of a system including a device that supports management of wireless fronthaul links in accordance with one or more aspects of the present disclosure.

FIGS. 10 through 13 show flowcharts illustrating methods that support management of wireless fronthaul links in accordance with one or more aspects of the present disclosure.

### DETAILED DESCRIPTION

In some examples, a wireless fronthaul network may provide benefits over a wired (e.g., fiber-based) fronthaul for communications. For example, a wireless fronthaul network may provide higher capacity and scalability for links between a DU and one or more RUs. The wireless fronthaul network may also be associated with lower upfront (e.g., setup) costs relative to fiber-based fronthaul networks. In some cases, demands from a radio access network (e.g., a Uu access network) may change over time, and the wireless fronthaul network may benefit from dynamic adaptations to the changes in demand. Managing adaptations to support the changes in demand, however, may be associated with increased computations and processing, which may lead to increased overhead and power utilization, among other issues, at a DU or RU. As such, improving management associated with fronthaul communications of a wireless network may be beneficial to reduce overhead and computations and to increase network resource usage and efficiency, among other benefits.

In accordance with examples as described herein, an FNC may be used to manage operations of the wireless fronthaul network. The FNC may monitor network conditions or parameters, or both, by monitoring traffic, resource utilization, or allocation of one or more communication links. In one example, the FNC may receive messages indicating one or more network conditions and parameters from one or more DUs or RUs of a network, where the network includes a fronthaul network and a radio access network. The FNC may adapt one or more parameters for a DU of the network based on the network conditions and parameters. For example, the FNC may receive information relating to fronthaul network demand, available resources, RU positioning information, and other information, and the FNC may determine one or more parameters or resources to be used by the DU based on the received information. In some examples, the FNC may indicate panel assignments, beamforming weights, or a multiplexing mode to the DU. In some cases, the multiplexing mode may be selected by the FNC from one of time-division multiplexing (TDM) mode, a frequency-division multiplexing (FDM) mode (e.g., an orthogonal FDM (OFDM) mode), a spatial-division multiplexing (SDM) mode, or a hybrid combination thereof, based on the positioning of RUs associated with the DU. Accordingly, management operations provided by the FNC may improve resource utilization, reduce latency, and increase operation efficiency of the wireless fronthaul network, while reducing overhead and computations performed by a DU or an RU.

Aspects of the disclosure are initially described in the context of wireless communications systems and network architectures. Aspects of the disclosure are additionally described in the context of process flows. Aspects of the disclosure are further illustrated by and described with reference to apparatus diagrams, system diagrams, and flowcharts that relate to management of wireless fronthaul links.

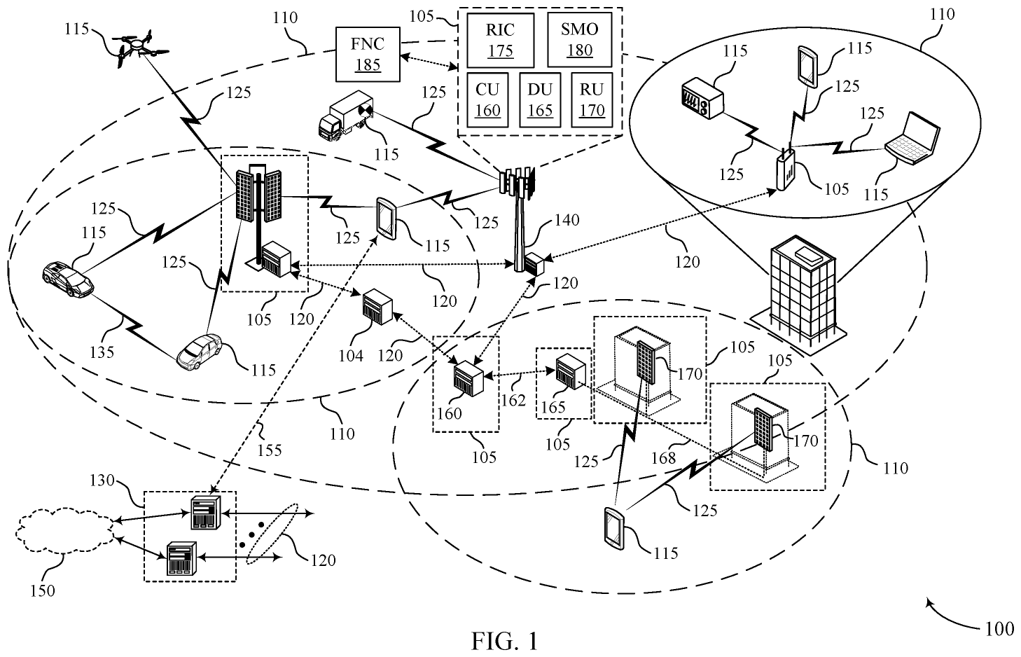

FIG. 1 shows an example of a wireless communications system 100 that supports management of wireless fronthaul links in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a DU 165, an RU 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions.

A CU 160 may be connected to one or more DUs 165 via a midhaul communication link 162 (e.g., F1, F1-c. F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links. In some examples, a CU 160, a DU 165, and RUs 170 may each use one or more antennas or antenna panels to communicate via the fronthaul communication link 168 (e.g., a wireless fronthaul link) or the midhaul communication link 162 (e.g., a wireless midhaul link).

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support management of wireless fronthaul links as described herein. For example, some operations described as being performed by a UE 115 or a network entity 105 (e.g., a base station 140, a DU 165, an RU 170) may additionally, or alternatively, be performed by one or more (e.g., other) components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as OFDM or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of TDM techniques, FDM techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking. Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some examples, a wireless fronthaul network may provide advantages over a wired (e.g., fiber-based) fronthaul for communications within the communications system 100. For example, a wireless fronthaul network may provide higher capacity and scalability for links between a DU 165 and one or more RUs 170. The wireless fronthaul network may also be associated with lower upfront costs relative to fiber-based fronthaul networks. In some cases, demands from a radio access network (e.g., a Uu access network) may change over time, and the wireless fronthaul network may benefit from dynamic adaptations to the changes in demand. Managing adaptations to support the changes in demand, however, may be associated with large amounts of computations and processing, which may increase overhead at a DU 165 or an RU 170 if these devices were to perform such management. As such, improving management associated with fronthaul communications of a wireless network may be beneficial.

In accordance with examples as described herein, an FNC 185 may be used to manage operations of the wireless fronthaul network. The FNC 185 may receive messages indicating network condition and parameters from one or more DUs 165 or RUs 170 of a network (e.g., the wireless communications system 100), which may include a fronthaul network and a radio access network. The FNC 185 may adapt one or more parameters for a DU 165 of the network based on the network conditions and parameters. For example, the FNC 185 may receive information relating to fronthaul network demand, available resources, RU positioning information, and other information, and the FNC 185 may determine one or more parameters or resources to be used by the DU 165 based on the received information. In some examples, the FNC 185 may indicate panel assignments, beamforming weights, or a multiplexing mode to a DU 165. In some cases, the multiplexing mode may be selected by the FNC 185 from one of a TDM mode, an FDM mode, an SDM mode, or a hybrid combination thereof, based on the positioning of RUs 170 associated with a DU 165. In some examples, the FNC 185 may be implemented at a near-real time RIC 175 or a non-real time RIC 175. Accordingly, management operations provided by the FNC 185 may improve resource utilization, reduce latency, and increase operation efficiency of the wireless fronthaul network.

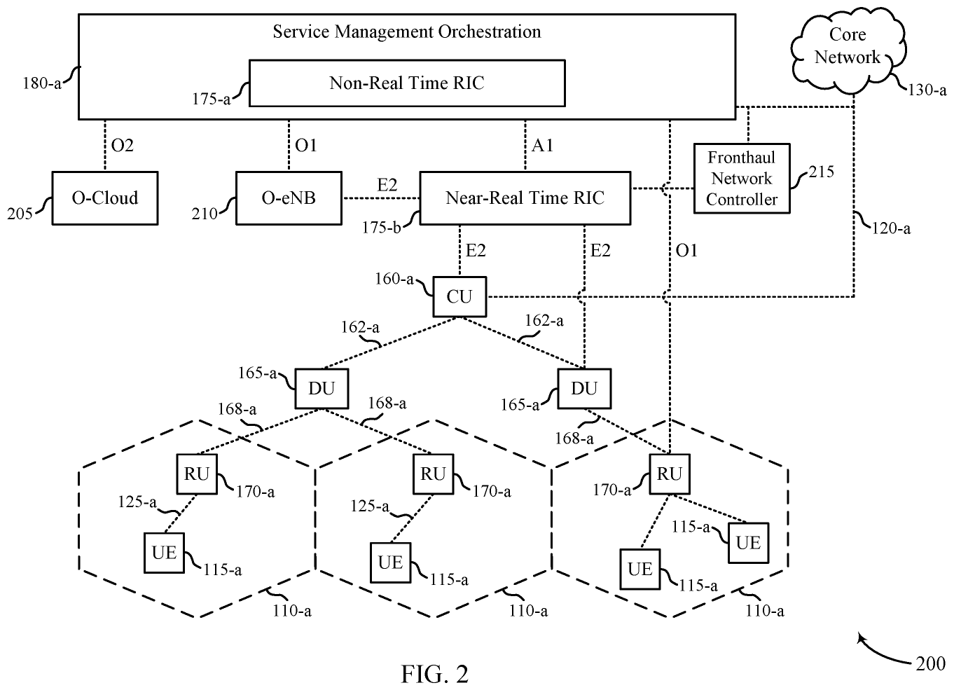

FIG. 2 shows an example of a network architecture 200 (e.g., a disaggregated base station architecture, a disaggregated RAN architecture) that supports management of wireless fronthaul links in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a. DUs 165-a. RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

In some examples, a wireless fronthaul network may provide advantages over a wired (e.g., fiber-based) fronthaul for communications within the network architecture 200. For example, a wireless fronthaul network may provide higher capacity and scalability for links between a DU 165 and one or more RUs 170. The wireless fronthaul network may also be associated with lower upfront costs relative to fiber-based fronthaul networks. In some cases, demands from a radio access network (e.g., a Uu access network) may change over time, and the wireless fronthaul network may benefit from dynamic adaptations to the changes in demand. Managing adaptations to support the changes in demand, however, may be associated with large amounts of computations and processing, which may increase overhead at a DU 165 or an RU 170 if these devices were to perform such management. As such, improving management associated with fronthaul communications of a wireless network may be beneficial.

In accordance with examples as described herein, an FNC 215 may be implemented to manage operations of a wireless fronthaul network. The FNC 215 may receive messages indicating one or more network conditions and parameters from one or more DUs 165 or RUs 170 of a network (e.g., based on the network architecture 200), which may include the wireless fronthaul network and a radio access network. The FNC 215 may adapt one or more parameters for a DU 165 of the network based on the one or more network conditions and the parameters. For example, the FNC 215 may receive information relating to fronthaul network demand, available resources, RU positioning information, and other information, and the FNC 215 may determine one or more fronthaul operation parameters (e.g., configurations, parameters, and other information) to be used by a DU 165 based on the received information. In some examples, the fronthaul operation parameters may include panel assignments, beamforming weights, or a multiplexing mode for use by the DU 165, and the FNC 215 may output an indication of the fronthaul operation parameters to the DU 165. In some cases, the multiplexing mode may be selected by the FNC from one of a TDM mode, an FDM mode, an SDM mode, or a hybrid combination thereof, based on the positioning of RUs 170 associated with a DU 165.

In some examples, the FNC 215 may be implemented at the non-real time RIC 175-a, the near-real time RIC 175-b, or both. For example, the FNC 215 may be implemented as an application (e.g., an rApp) within the non-real time RIC 175-a, or as an application (e.g., an xApp) within the near-real time RIC 175-b, or both. Accordingly, functions performed by the FNC 215, as described herein, may be performed by one or both of the non-real time RIC 175-a and the near-real time RIC 175-b. Similarly, the non-real time RIC 175-a, the near-real time RIC 175-b, or both, may be implemented within a network entity 105, and function performed by the FNC 215 as described herein may be performed by the network entity 105.

In some examples, the FNC 215 may output the one or more operational parameters to the DU 165-a via the O1 interface (e.g., if the FNC 215 is implemented within the non-real time RIC 175-a) or via the E2 interface (e.g., if the FNC 215 is implemented within the near-real time RIC 175-b). For example, the FNC 215 (e.g., or the non-real time RIC 175-a) may transmit an O1 message indicating the one or more fronthaul operation parameters to the DU 165-a via the O1 interface. Additionally, or alternatively, the FNC 215 (e.g., or the near-real time RIC 175-b) may transmit an E2 message indicating the one or more fronthaul operation parameters to the DU 165-a via the E2 interface.

By outputting the one or more operational parameters to the DU 165-a, the FNC 215 may support management operations that improve resource utilization, reduce latency, and increase operation efficiency of the wireless fronthaul network.

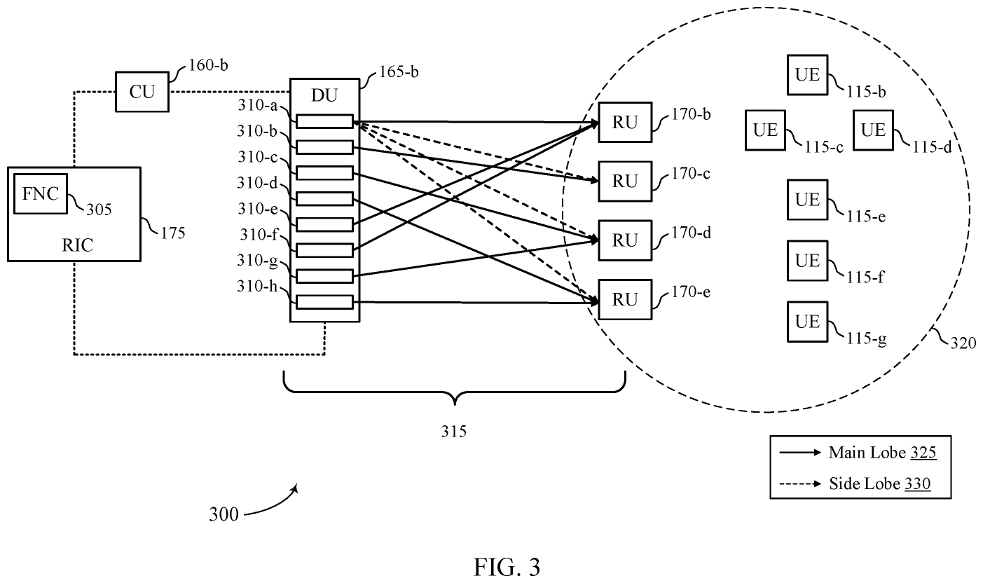

FIG. 3 shows an example of a wireless communications system 300 that supports management of wireless fronthaul links in accordance with one or more aspects of the present disclosure. The wireless communications system 300 may implement aspects of the wireless communications system 100 and the network architecture 200. For example, the wireless communications system 300 may include a CU 160-b, a DU 165-b, an RU 170-b, an RU 170-c, an RU 170-d, an RU 170-e, an RIC 175-c, and an FNC 305, which may be examples of the corresponding components or devices as described herein, with reference to FIGS. 1 and 2. Further, the wireless communications system 300 may include multiple UEs 115 in communication with the one or more RUs 170, including a UE 115-b, a UE 115-c, a UE 115-d, a UE 115-e, a UE 115-f, and a UE 115-g, which may be examples of a UE 115 as described herein.

In some examples, the RIC 175-c may incorporate the FNC 305 (e.g., as software such as an application, for example an xApp or an rApp) to manage wireless fronthaul operations of the wireless communications system 300. As such, to perform such functions, the FNC 305 and the RIC 175-c may perform communications with the CU 160-b and the DU 165-b. In some examples, the RIC 175-c may be an example of a near-real time RIC 175 or a non-real time RIC 175 as described herein, with reference to FIGS. 1 and 2.

In some examples, the DU 165-b may be equipped with one or more antenna panels 310, such as antenna panel 310-a, antenna panel 310-b, antenna panel 310-c. antenna panel 310-d, antenna panel 310-e, antenna panel 310-f, antenna panel 310-g. and antenna panel 310-h. The DU 165-b may communicate with of one or more of the RUs 170 (e.g., of the RU 170-b, the RU 170-c, the RU 170-d, and the RU 170-e) via fronthaul communication links, which may include one or more main lobes 325, one or more side lobes 330, or a combination thereof, with the RUs 170. For example, the fronthaul communication link between the DU 165-b and the RU 170-e may include two main lobes 325 (e.g., associated with the antenna panel 310-d and the antenna panel 310-h, respectively) and a side lobe 330 (e.g., associated with the antenna panel 310-a).

In some cases, main lobes 325 may refer to a beam of an antenna panel 310 having a largest signal strength, while other beams (e.g., that may be aimed in other directions) having a relatively lower signal strength may be referred to as side lobes 330. The DU 165-b may assign antenna panels to multiple of the RUs 170 using a combination of main lobes 325 and side lobes 330. For example, the antenna panel 310-a may be assigned to a fronthaul communication link with the RU 170-b, and may include a main lobe 325 directed toward the RU 170-b. The antenna panel 310-a may additionally be assigned to other RUs 170 using side lobes 330 each directed toward one of the RU 170-c, the RU 170-d, and the RU 170-e, for example. In some examples, the fronthaul communication links may be examples of point-to-point or point-to-multi-point communication links between the DU 165-b and the RUs 170.

In some examples, the FNC 305 may adapt network parameters or resources in response to changes in network conditions or parameters associated with a fronthaul network 315 (e.g., a wireless fronthaul network) or a radio access network 320 (e.g., a Uu access network) of the wireless communications system 300. The fronthaul network 315 may refer to the DU 165-b and the RUs 170, fronthaul communication links between these (e.g., main lobes 325 and side lobes 330), or any combination thereof. Further, the radio access network 320 may refer to the RUs 170 and wireless devices (e.g., the UEs 115) for which the RUs 170 may support wireless communications, communication links (e.g., Uu links) between the RUs 170 and the wireless devices, or any combination thereof.

To perform management operations, the FNC 305 may monitor the one or more network conditions and the parameters associated with the wireless communications system 300 (e.g., the fronthaul network 315, the radio access network 320, or both). In some examples, the FNC 305 may obtain an indication of one or more network conditions, which may include a positioning information (e.g., spatial locations) associated with the RUs 170, available resources (e.g., antenna panels 310, beams of an antenna panel 310, time or frequency resources, or a combination thereof) at the DU 165-b or one or more of the RUs 170, capability information associated with the DU 165-b or the RUs 170. Additionally, or alternatively, the FNC 305 may obtain an indication of one or more network parameters (e.g., targets) such as a traffic load associated with the radio access network 320 or a delay budget (e.g., limit) associated with one or more of the UEs 115, a quantity of co-scheduled spatial layers or streams, a quantity of aggregated component carriers, or any combination thereof. In some examples, the indication of the traffic load may be a measurement of the traffic load as a data rate (e.g., a data rate of a total of transmissions in the radio access network 320) or as a quantity of supported spatial streams (e.g., in the radio access network 320).

In some examples, to obtain an indication of the one or more network conditions and the parameters, the FNC 305 may receive a message transmitted by the CU 160-b, the DU 165-b, one or more of the RUs 170, or a combination thereof, that may indicate the one or more network conditions or parameters. In some cases, messages communicated between the FNC 305 and the CU 160-b, the DU 165-b, or one or more of the RUs 170, may be communicated via an E2 interface, an O1 interface, or another interface, as described herein with reference to FIG. 2.

In some examples, the one or more network parameters may include capability information, and the FNC 305 may monitor for capability information of the DU 165-b, one or more of the RUs 170, or any combination thereof. For example, the DU 165-b may output (e.g., transmit a message indicating) capability information of the DU 165-b, of one or more of the RUs 170, or a combination thereof. In some examples, the capability information for a device (e.g., the DU 165-b or one of the RUs 170) may include a quantity of antenna panels available at the device, a quantity of layers (e.g., communication layers) supported by the device, available beams at the device, the beam width of such beams, an effective (e.g., or equivalent) isotropic radiated power (EIRP) associated with each antenna panel of the device, or a combination thereof.

In some examples, the DU 165-b may receive one or more messages indicating one or more network conditions or parameters (e.g., or both) from one or more of the RUs 170, and the DU 165-b may forward (e.g., output, transmit a message indicating) the one or more network conditions or parameters to the FNC 305 (e.g., via the RIC 175 through an E2 interface or an O1 interface). In some cases, the messages received by the DU 165-b from one or more of the RUs 170 may be communicated via a control plane (e.g., using control messages), a user plane, or via management messages, for example.

The FNC 305 may select one or more fronthaul operation parameters for use by the DU 165-b or one or more of the RUs 170 based on the one or more network conditions and the parameters, and the FNC 305 may output the one or more fronthaul operation parameters (e.g., to the DU 165-b or the CU 160-b). In some examples, the one or more fronthaul operation parameters may include configurations (and related parameters) for a fronthaul communication link between the DU 165-b and one or more of the RUs 170 and may include one or more of a change in an operation mode (e.g., multiplexing mode, activation mode (active, inactive)), a reallocation of fronthaul access network resources, or parameter reconfigurations. For example, the one or more fronthaul operation parameters may include antenna panel assignments, beamforming weights, a quantity of antenna panels 310 per fronthaul communication link with an RU 170 of the RUs 170, (e.g., a given (e.g., minimum or maximum) quantity of antenna panels 310 to be assigned to each RU 170), a transmit power for each antenna panel 310, a quantity of resources assigned to each fronthaul communication link (e.g., a quantity (e.g., maximum or minimum quantity) of main lobes 325, side lobes 330, or both, assigned to a fronthaul communication link), or any combination thereof. In some examples, the one or more fronthaul operation parameters may be or include Layer 1 parameters, such as Physical Layer parameters, of the fronthaul network 315, Layer 2 parameters, such as MAC Layer, RLC Layer, or PDCP Layer parameters, of the fronthaul network 315, or any combination thereof.

In some examples, selecting, determining, obtaining, or outputting one or more fronthaul operation parameters may be based on the FNC 305 detecting a change in the one or more network conditions or parameters being monitored by the FNC 305. For instance, the FNC 305 may determine that a change in the one or more network conditions and the parameters exceeds a threshold value and may output the one or more fronthaul operation parameters based on the change exceeding the threshold value. For example, the FNC 305 may determine that a traffic load associated with the radio access network 320 has increased (e.g., exceeds a threshold value), and may signal the DU 165-b to activate additional carrier components, or to increase a quantity of antenna panels 310 used for serving a fronthaul communication link between the DU 165-b and one or more of the RUs 170 (e.g., by adding main lobes 325 or side lobes 330 directed to the one or more of the RUs 170) based on the increase in the traffic load. Similarly, the FNC 305 may determine that a network capacity value (e.g., limit) associated with the radio access network 320 has increased (e.g., past a threshold value), and may output updated resources (e.g., fronthaul operation parameters as described herein) for use by the DU 165-b based on the increase in the capacity limit.

In some examples, the selected fronthaul operation parameters may be based on whether the increased capacity value or the increased traffic load can be accommodated by the DU 165-b, and the FNC 305 may perform other actions otherwise. For example, the FNC 305 may determine that the DU 165-b can accommodate an additional RU 170 and indicate the DU 165-b to communicate with the additional RU 170. In these examples, in response to determining that the increase load or capacity can be accommodated, the FNC 305 may change or redistribute resources (e.g., quantity of antenna panels 310 of the DU 165-b or one or more of the RUs 170 per link, transmit power for each antenna panel 310, or a quantity of time or frequency resources assigned to each fronthaul communication link) or other fronthaul operation parameters as described herein, and the DU 165-b may obtain an indication of the updated resources or the fronthaul operation parameters selected by the FNC 305.

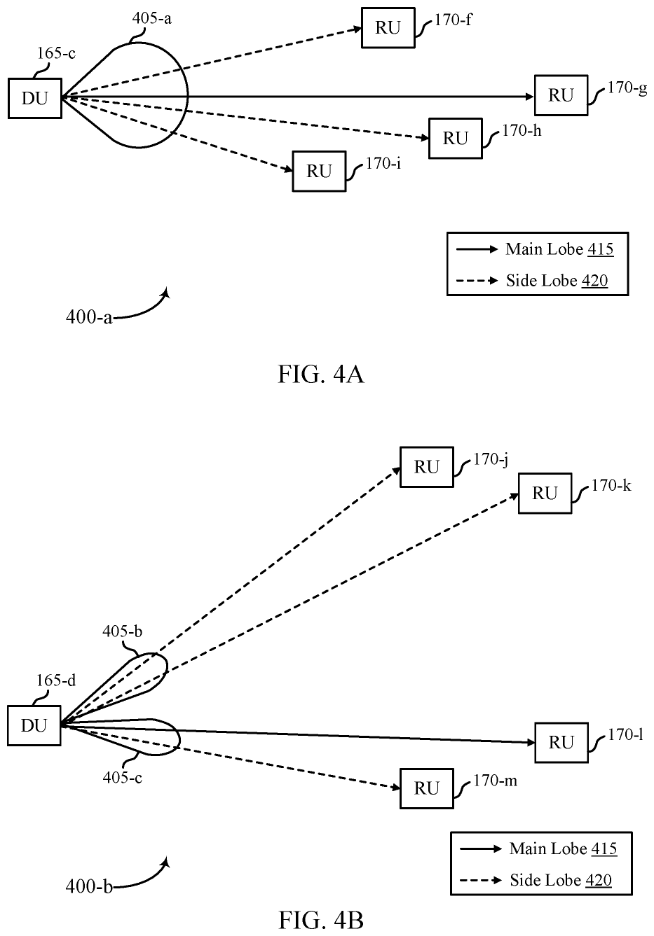

The FNC 305 may select a multiplexing mode for the DU 165-a based on the one or more network conditions and the parameters. In some examples, the FNC 305 may select the multiplexing mode from an SDM mode, an FDM mode, a TDM mode, or a hybrid mode that incorporates aspects from two or more of these modes. In some cases, the selection of the multiplexing mode may be based on the positioning information of the RUs 170. Example scenarios and other selection criteria for selecting the multiplexing mode are described in more detail herein, with reference to FIGS. 4A and 4B.

The DU 165-b may apply (e.g., at least some of) the one or more fronthaul operation parameters selected by the FNC 305, and the DU 165-b may support performing wireless communications with the RUs 170 based on the one or more fronthaul operation parameters. In some examples, the DU 165-b may output (e.g., forward, transmit) an indication of (e.g., at least) a portion of the one or more fronthaul operation parameters to one or more of the RUs 170. For example, the DU 165-b may have received an indication of one or more fronthaul operation parameters selected by the FNC 505 for one or more of the RUs 170, such as antenna panel assignments, beamforming weights, or other fronthaul operation parameters, and the DU 165-b may forward these fronthaul operation parameters. Additionally, or alternatively, the DU 165-e may indicate the RUs 170 of changes or updated occurring at the DU 165-e (e.g., beam changes, antenna panel assignment changes) based on the received fronthaul operation parameters. In some examples, the DU 165-b may communicate the indications of fronthaul operation parameters or of the changes at the DU 165-b via a control plane (e.g., using control messages), a user plane, or via one or more management messages. Accordingly, one or more of the RUs 170 may apply one or more fronthaul operation parameters, for example, if the one or more of the RUs 170 received an indication of the portion of the one or more fronthaul operation parameters from the DU 165-b.

By including and using the FNC 305 for management of fronthaul operation parameters for the DU 165-b and the RUs 170, the wireless communications system 300 may adapt to changes in the radio access network 320 or the fronthaul network 315, while experiencing improved resource utilization, reduced latency, and increased operational efficiency.

FIG. 4A shows an example of a wireless communications system 400-a that supports management of wireless fronthaul links in accordance with one or more aspects of the present disclosure. The wireless communications system 400-a may implement aspects of the wireless communications system 300, as described herein with reference to FIG. 3. For example, the wireless communications system 400-a may be an example of a fronthaul network 315, and the wireless communications system 400-amay include a DU 165-c, an RU 170-f, an RU 170-g, an RU 170-h, and an RU 170-i, which may be examples of corresponding components as described herein with reference to FIGS. 1 through 3. The DU 165-c may support fronthaul communication links with the RUs 170 (e.g., the RU 170-f, the RU 170-g, the RU 170-h, and the RU 170-i) using one or more beams 405 having one or more main lobes 415 and side lobes 420, which may be examples of a main lobe 325 and a side lobe 330, respectively, as described herein with reference to FIG. 3.

In some examples, the wireless communications system 400-a may incorporate an FNC, as described herein. The FNC may monitor one or more network conditions and parameters of the wireless communications system 400-a, which may be an example of a radio access network 320 as described herein. Further, the FNC may select one or more fronthaul operation parameters for use by the DU 165-c or one or more of the RUs 170 based on the one or more network conditions and the parameters, and the FNC 305 may output the one or more fronthaul operation parameters (e.g., by transmitting a message indicating the one or more fronthaul operation parameters to the DU 165-c). In some examples, the one or more fronthaul operation parameters may include a multiplexing mode for use by the DU 165-c.

The FNC may select a multiplexing mode from an SDM mode, an FDM mode, a TDM mode, or a hybrid mode that incorporates aspects from two or more of these modes for use by the DU 165-c based on the one or more network conditions and the parameters of the wireless communications system 400-a, as described herein with reference to FIG. 3. In some examples, a desired capacity or latency may serve as a selection criteria for the multiplexing mode. For example, an SDM mode may be selected if a higher capacity (e.g., quantity of RUs 170) is desired, as SDM may support a higher capacity of RUs 170 relative to an FDM mode or a TDM mode. However, a quantity of antenna panels may also be considered for selecting the multiplexing mode in some examples. For instance, an SDM mode may be associated with a (e.g., minimum) quantity of antenna panels at the DU 165-c, and another mode may be selected if the quantity is not met. In other examples, a TDM mode may be selected if a lower latency is desired, as TDM may be associated with a lower latency relative to an SDM mode or an FDM mode.

In some examples, the FNC may select a multiplexing mode based on positioning information (e.g., spatial location data) associated with the RUs 170. In some examples, the DU 165-c, the RUs 170, or both, may output positioning information associated with the RUs 170, which may be obtained by the FNC. For example, the RUs 170 may each indicate positioning information to the DU 165-c, which may transmit a message that may indicate the positioning information to the FNC. Additionally, or alternatively, the RUs 170 may directly transmit a message indicating the position information to the FNC. In some examples, the positioning information may indicate that the RUs 170 are positioned in relatively well-separated locations. The FNC may select an SDM mode for the DU 165-c in these examples, which may have improved performance when RUs 170 are well spaced. In some other cases, the FNC 305 may determine to use a TDM mode, for example, if criteria for other modes are not met, or if the FNC 305 has not obtained positioning information.

Alternatively, and as illustrated in FIG. 4, the positioning information may indicate that the RUs 170 are positioned in relatively close spatial locations. In these examples, the FNC may select the FDM mode, which may have improved performance when RUs 170 are located in close proximity (e.g., azimuthally) and may indicate the DU 165-c to utilize the FDM mode using a beam 405-a. In some examples, the DU 165-c may direct the beam 405-a towards a spatial location of the furthest RU 170 (e.g., the RU 170-g), which may be indicated by the FNC. For example, a main lobe of the beam 405-a may be directed toward the RU 170-g, while one or more side lobes of the beam 405-a may be directed toward the RU 170-f, the RU 170-h, and the RU 170-i, as closer RUs 170 may operate while not being fully within a highest beam power (e.g., received power or signal, beam maximum). Similarly, beams 405 of all antenna panels of the DU 165-c may be configured (e.g., by the FNC) to be directed toward the spatial location of the RU 170-g.

FIG. 4B shows an example of a wireless communications system 400-b that supports management of wireless fronthaul links in accordance with one or more aspects of the present disclosure. The wireless communications system 400-b may implement aspects of the wireless communications system 300, as described herein with reference to FIG. 3. For example, the wireless communications system 400-b may be an example of a fronthaul network 315, and the wireless communications system 400-b may include a DU 165-d, an RU 170-j, an RU 170-k, an RU 170-l, and an RU 170-m, which may be examples of corresponding components as described herein with reference to FIGS. 1 through 4A. The DU 165-d may support fronthaul communication links with the RUs 170 (e.g., the RU 170-j, the RU 170-k, the RU 170-l, and the RU 170-m) using one or more beams 405 having one or more main lobes 415 and side lobes 420, which may be examples of a main lobe 325 and a side lobe 330, respectively, as described herein with reference to FIG. 3.

In some examples, the wireless communications system 400-a may incorporate an FNC, as described herein. The FNC may select a multiplexing mode from an SDM mode, an FDM mode, a TDM mode, or a hybrid mode that incorporates aspects from two or more of these modes for use by the DU 165-d based on one or more network conditions and parameters of the wireless communications system 400-a, as described herein with reference to FIGS. 3 and 4A.

In some examples, and as illustrated in FIG. 4B, the positioning information may indicate that the RUs 170 are generally located within multiple clusters or groups located at different distances, but that RUs 170 within the clusters are located relatively close spatially. In these examples, the FNC may select a hybrid SDM/FDM mode as the multiplexing mode for the DU 165-d. For example, the FNC may indicate (e.g., by outputting messages via an E2 interface or an O1 interface, as described herein) the DU 165-d to utilize a hybrid SDM/FDM for communications with the RUs 170 using a beam 405-b and a beam 405-c. In some examples, each beam may be directed at a spatial location of a cluster of one or more RUs 170. For example, the beam 405-b may be directed toward a spatial location associated with the RU 170-j and the RU 170-k, and the beam 405-c may be directed toward a spatial location associated with the RU 170-l and the RU 170-m (e.g., as configured by the FNC). In some examples, when the DU 165-d operates with the hybrid SDM/FDM mode, different clusters of one or more RUs 170 may be multiplexed according to SDM, and each respective RU 170 of a cluster may be assigned an orthogonal frequency resource in accordance with an FDM mode (e.g., an OFDM mode).

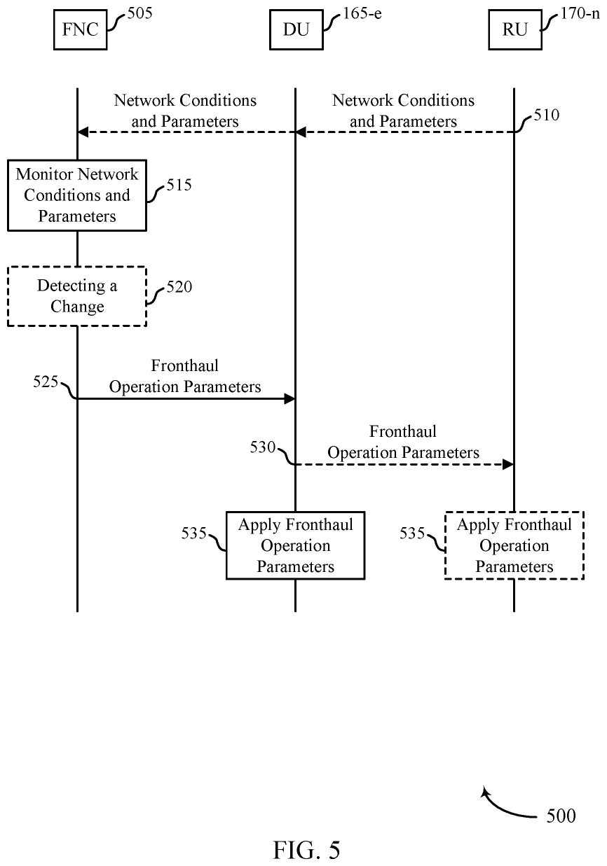

FIG. 5 shows an example of a process flow 500 that supports management of wireless fronthaul links in accordance with one or more aspects of the present disclosure. The process flow 500 may include an FNC 505, a DU 165-e, and an RU 170-n, which may be examples of corresponding components as described herein, with reference to FIGS. 1 through 4B. In some examples, the DU 165-e and the RU 170-n may be a part of a wireless fronthaul network, as described herein, and may engage in communications via one or more fronthaul communication links.

In some examples, messages may be communicated between the FNC 505 and the DU 165-e, the RU 170-n, or both, via an E2 interface, an O1 interface, or another interface, as described herein with reference to FIGS. 2 and 3. For example, the FNC 505 may be incorporated (e.g., as an application, such as an rApp or an xApp) within an RIC 175 (e.g., a non-real time RIC 175 or a near-real time RIC 175), as described herein, and the RIC may exchange messages or signaling with the DU 165-e, the RU 170-n, or both (e.g., directly or via a CU 160).

At 510, the DU 165-e may output an indication of one or more network conditions and parameters associated with the wireless fronthaul network or a radio access network (e.g., associated with communications between the RU 170-n and one or more wireless devices). For example, the DU 165-e may transmit a message (e.g., via an E2 interface or an O1 interface) to the FNC 505 or another device (e.g., a CU 160, or an RIC 175). In some examples, the DU 165-e may receive one or more messages from the RU 170-n (e.g., via a control plane using control messages, a user plane, or via management messages) indicating one or more network conditions and parameters, and the DU 165-e may forward the one or more network conditions and the parameters to the FNC 505. Additionally, or alternatively, the RU 170-n may directly transmit a message indicating one or more network conditions or parameters, or both, to the FNC 505 (e.g., via transmitting one or more messages).

At 515, the FNC 505 may monitor one or more network conditions and parameters associated with the wireless fronthaul network. In some examples, the one or more network conditions and the parameters may include available resources at the DU 165-e, a traffic load of the fronthaul access network, a delay budget associated with one or more wireless devices (e.g., UEs 115) supported by the RU 170-n, a quantity of antenna panels per fronthaul communication link, a transmit power for each antenna panel, a quantity of resources assigned to each fronthaul communication link, positioning information of the RU 170-n and other RUs 170, capability information of the DU 165-e, the RU 170-n, or both, or any combination thereof. In some examples, the FNC 505 may obtain (e.g., by receiving messages via an E2 interface or an O1 interface) some or all of the one or more network conditions and the parameters via the DU 165-e, the RU 170-n, or both.

At 520, the FNC 505 may detect a change in the one or more network conditions and the parameters. For example, the FNC 505 may detect that a change in the one or more network conditions and the parameters exceeds a threshold value. The FNC 505 may select one or more fronthaul operation parameters based on detecting the change that exceeds the threshold value. For example, the FNC 505 may detect that a change (e.g., increase) in a traffic load associated with the fronthaul access network exceeds a threshold value, and the FNC 505 may output a message indicating for the DU 165-e to activate one or more carrier components, one or more serving antenna panels, or a combination thereof.

At 525, the FNC 505 may output (e.g., via an E2 message or an O1 message) an indication of one or more fronthaul operation parameters selected or generated based on the one or more network conditions and the parameters. In some examples, the one or more fronthaul operation parameters may include a multiplexing mode (e.g., an TDM mode, a SDM mode, an FDM mode, or a hybrid combination thereof), antenna panel assignments for the DU 165-e, the RU 170-n, or both, beamforming weights for the DU 165-e, the RU 170-n, or both, Layer 1 parameters, Layer 2 parameters, or any combination thereof.

At 530, the DU 165-e may output (e.g., forward, transmit) an indication of (e.g., at least) a portion of the one or more fronthaul operation parameters to the RU 170-n. For example, the DU 165-e may have received an indication of one or more fronthaul operation parameters selected by the FNC 505 for the RU 170-n, such as antenna panel assignments, beamforming weights, or other fronthaul operation parameters, and the DU 165-e may forward these fronthaul operation parameters. Additionally, or alternatively, the DU 165-e may indicate the RU 170-n of changes at the DU 165-e based on received fronthaul operation parameters. In some examples, the DU 165-e may communicate the indications of fronthaul operation parameters or of the changes at the DU 165-e via a control plane (e.g., using control messages), a user plane, or via one or more management messages.

At 535, the DU 165-e may apply (e.g., at least some of) the one or more fronthaul operation parameters, and perform wireless communications operations based on the one or more fronthaul operation parameters. Similarly, the RU 170-n may apply the portion of the one or more fronthaul operation parameters, for example, if the RU 170-n received an indication of the portion of the one or more fronthaul operation parameters from the DU 165-e.

By using the FNC 505 to manage fronthaul operation parameters for the DU 165-e and the RU 170-n, the fronthaul access network may adapt to changes in network conditions and parameters while experiencing improved resource utilization, reduced latency, and increased operational efficiency.

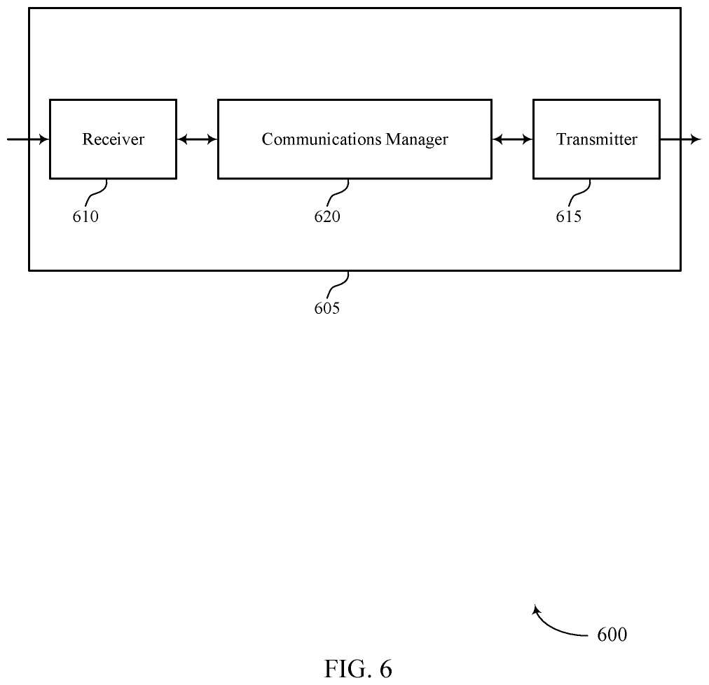

FIG. 6 shows a block diagram 600 of a device 605 that supports management of wireless fronthaul links in accordance with one or more aspects of the present disclosure. The device 605 may be an example of aspects of a network entity 105 as described herein. The device 605 may include a receiver 610, a transmitter 615, and a communications manager 620. The device 605 may also include a processor. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The communications manager 620, the receiver 610, the transmitter 615, or various combinations thereof or various components thereof may be examples of means for performing various aspects of management of wireless fronthaul links as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a network entity in accordance with examples as disclosed herein. For example, the communications manager 620 is capable of, configured to, or operable to support a means for monitoring one or more network conditions and parameters of a network, the network including a fronthaul network and a radio access network, where the fronthaul network includes at least one distributed unit supporting wireless communications for a set of multiple radio units via a set of multiple fronthaul communication links, and the radio access network includes the set of multiple radio units supporting communications for a set of multiple wireless devices. The communications manager 620 is capable of, configured to, or operable to support a means for outputting, based at least in part on the one or more network conditions and the parameters, one or more fronthaul operation parameters for the at least one distributed unit to support wireless communications for at least one radio unit of the set of multiple radio units via one or more respective fronthaul communication links of the set of multiple fronthaul communication links.

Additionally, or alternatively, the communications manager 620 may support wireless communication at a distributed unit in accordance with examples as disclosed herein. For example, the communications manager 620 is capable of, configured to, or operable to support a means for outputting one or more network conditions and parameters of a network, the network including a fronthaul network and a radio access network, where the fronthaul network includes at least the distributed unit that supports wireless communications for a set of multiple radio units via a set of multiple fronthaul communication links, and the radio access network includes the set of multiple radio units supporting communications for a set of multiple wireless devices. The communications manager 620 is capable of, configured to, or operable to support a means for obtaining, based at least in part on outputting the one or more network conditions and the parameters, one or more fronthaul operation parameters to support wireless communications for at least one radio unit of the set of multiple radio units via one or more respective fronthaul communication links of the set of multiple fronthaul communication links.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for managing a fronthaul network with reduced processing and power consumption at certain devices, providing for more efficient utilization of communication resources.

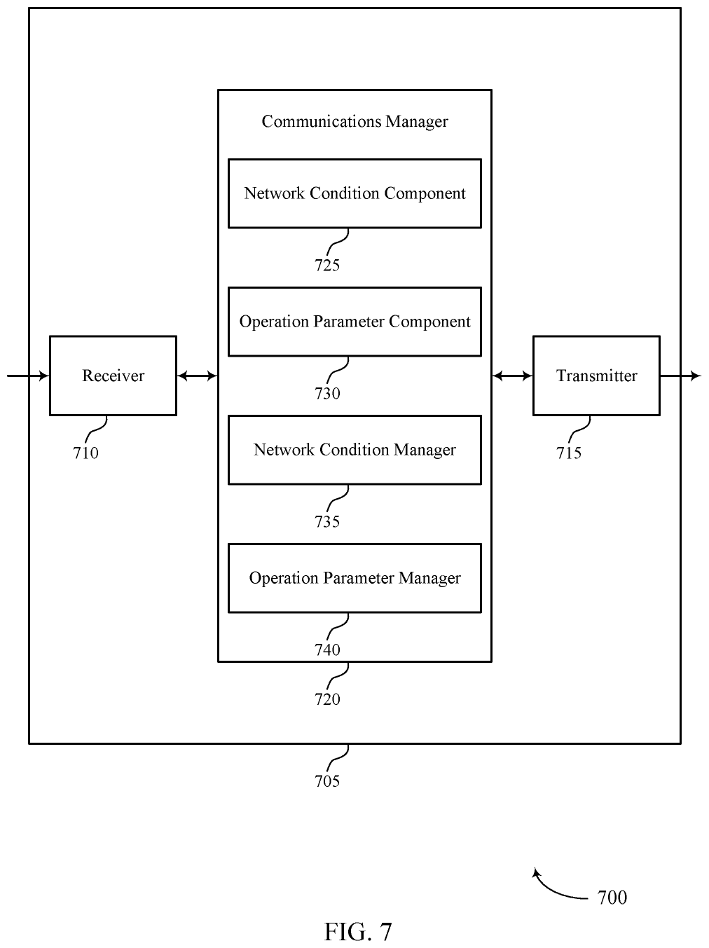

FIG. 7 shows a block diagram 700 of a device 705 that supports management of wireless fronthaul links in accordance with one or more aspects of the present disclosure. The device 705 may be an example of aspects of a device 605 or a network entity 105 as described herein. The device 705 may include a receiver 710, a transmitter 715, and a communications manager 720. The device 705 may also include a processor. Each of these components may be in communication with one another (e.g., via one or more buses).

The receiver 710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 705. In some examples, the receiver 710 may support obtaining information by receiving signals via one or more antennas. Additionally, or alternatively, the receiver 710 may support obtaining information by receiving signals via one or more wired (e.g., electrical, fiber optic) interfaces, wireless interfaces, or any combination thereof.

The transmitter 715 may provide a means for outputting (e.g., transmitting, providing, conveying, sending) information generated by other components of the device 705. For example, the transmitter 715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 715 may support outputting information by transmitting signals via one or more antennas. Additionally, or alternatively, the transmitter 715 may support outputting information by transmitting signals via one or more wired (e.g., electrical, fiber optic) interfaces, wireless interfaces, or any combination thereof. In some examples, the transmitter 715 and the receiver 710 may be co-located in a transceiver, which may include or be coupled with a modem.

The device 705, or various components thereof, may be an example of means for performing various aspects of management of wireless fronthaul links as described herein. For example, the communications manager 720 may include a network condition component 725, an operation parameter component 730, a network condition manager 735, an operation parameter manager 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a network entity in accordance with examples as disclosed herein. The network condition component 725 is capable of, configured to, or operable to support a means for monitoring one or more network conditions and parameters of a network, the network including a fronthaul network and a radio access network, where the fronthaul network includes at least one distributed unit supporting wireless communications for a set of multiple radio units via a set of multiple fronthaul communication links, and the radio access network includes the set of multiple radio units supporting communications for a set of multiple wireless devices. The operation parameter component 730 is capable of, configured to, or operable to support a means for outputting, based on the one or more network conditions and the parameters, one or more fronthaul operation parameters for the at least one distributed unit to support wireless communications for at least one radio unit of the set of multiple radio units via one or more respective fronthaul communication links of the set of multiple fronthaul communication links.

Additionally, or alternatively, the communications manager 720 may support wireless communication at a distributed unit in accordance with examples as disclosed herein. The network condition manager 735 is capable of, configured to, or operable to support a means for outputting one or more network conditions and parameters of a network, the network including a fronthaul network and a radio access network, where the fronthaul network includes at least the distributed unit that supports wireless communications for a set of multiple radio units via a set of multiple fronthaul communication links, and the radio access network includes the set of multiple radio units supporting communications for a set of multiple wireless devices. The operation parameter manager 740 is capable of, configured to, or operable to support a means for obtaining, based on outputting the one or more network conditions and the parameters, one or more fronthaul operation parameters to support wireless communications for at least one radio unit of the set of multiple radio units via one or more respective fronthaul communication links of the set of multiple fronthaul communication links.

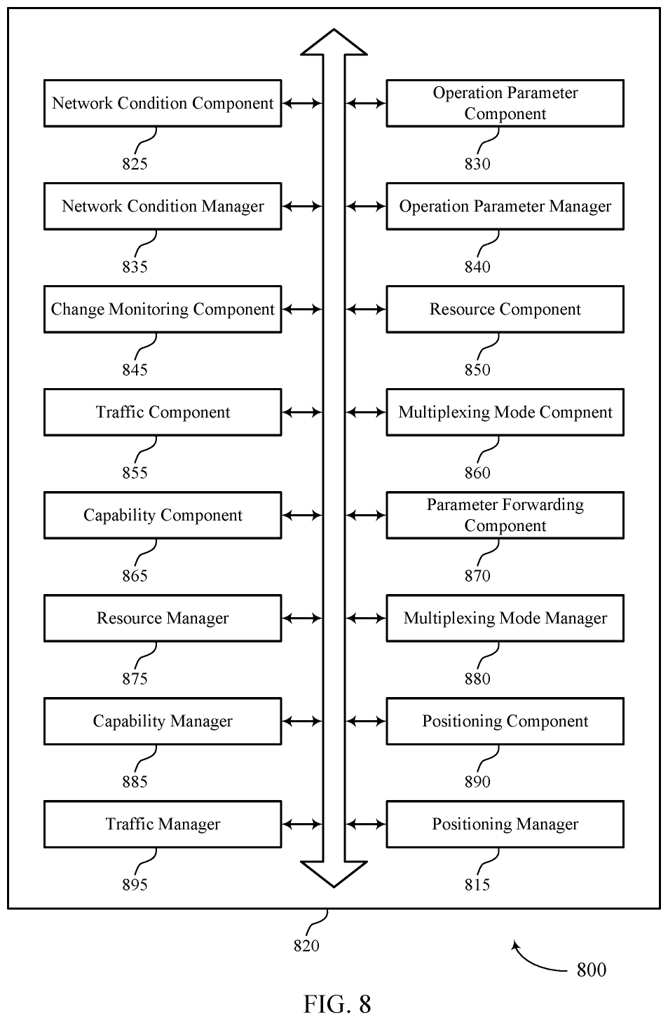

FIG. 8 shows a block diagram 800 of a communications manager 820 that supports management of wireless fronthaul links in accordance with one or more aspects of the present disclosure. The communications manager 820 may be an example of aspects of a communications manager 620, a communications manager 720, or both, as described herein. The communications manager 820, or various components thereof, may be an example of means for performing various aspects of management of wireless fronthaul links as described herein. For example, the communications manager 820 may include a positioning manager 815, a network condition component 825, an operation parameter component 830, a network condition manager 835, an operation parameter manager 840, a change monitoring component 845, a resource component 850, a traffic component 855, a multiplexing mode component 860, a capability component 865, a parameter forwarding component 870, a resource manager 875, a multiplexing mode manager 880, a capability manager 885, a positioning component 890, a traffic manager 895., or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 820 may support wireless communications at a network entity in accordance with examples as disclosed herein. The network condition component 825 is capable of, configured to, or operable to support a means for monitoring one or more network conditions and parameters of a network, the network including a fronthaul network and a radio access network, where the fronthaul network includes at least one distributed unit supporting wireless communications for a set of multiple radio units via a set of multiple fronthaul communication links, and the radio access network includes the set of multiple radio units supporting communications for a set of multiple wireless devices. The operation parameter component 830 is capable of, configured to, or operable to support a means for outputting, based on the one or more network conditions and the parameters, one or more fronthaul operation parameters for the at least one distributed unit to support wireless communications for at least one radio unit of the set of multiple radio units via one or more respective fronthaul communication links of the set of multiple fronthaul communication links.

In some examples, the change monitoring component 845 is capable of, configured to, or operable to support a means for detecting that a change in the one or more network conditions and the parameters of the network exceeds a threshold value, where outputting the one or more fronthaul operation parameters is based on detecting that the change exceeds the threshold value.

In some examples, the resource component 850 is capable of, configured to. or operable to support a means for obtaining an indication of available resources at the at least one distributed unit, where the one or more fronthaul operation parameters are based on the available resources.

In some examples, to support monitoring the one or more network conditions and the parameters, the traffic component 855 is capable of, configured to, or operable to support a means for monitoring a traffic load of the radio access network, a delay budget associated with the set of multiple wireless devices supported by the set of multiple radio units, an activation status of the at least one radio unit, or a combination thereof.

In some examples, the traffic component 855 is capable of, configured to, or operable to support a means for detecting that a change in the traffic load exceeds a threshold value, where the one or more fronthaul operation parameters are based on the change in the traffic load exceeding the threshold value, and the one or more fronthaul operation parameters include a quantity of antenna panels per fronthaul communication link of the set of multiple fronthaul communication links, a transmit power for each antenna panel, a quantity of resources assigned to each fronthaul communication link of the set of multiple fronthaul communication links, or any combination thereof.

In some examples, the traffic component 855 is capable of, configured to, or operable to support a means for detecting that an increase in the traffic load exceeds a threshold value. In some examples, the traffic component 855 is capable of, configured to, or operable to support a means for outputting, based on detecting that the increase in the traffic load exceeds the threshold value, a message indicating the at least one distributed unit to activate one or more carrier components associated with the set of multiple fronthaul communication links, one or more serving antenna panels associated with the set of multiple fronthaul communication links, or a combination thereof.

In some examples, to support outputting the one or more fronthaul operation parameters, the multiplexing mode component 860 is capable of, configured to, or operable to support a means for outputting a multiplexing mode for the at least one distributed unit, where the multiplexing mode is based on the one or more network conditions and the parameters of the network.

In some examples, the positioning component 890 is capable of, configured to, or operable to support a means for obtaining positioning information associated with the set of multiple radio units, where the one or more network conditions and the parameters includes the positioning information of the set of multiple radio units. In some examples, the multiplexing mode component 860 is capable of, configured to, or operable to support a means for selecting the multiplexing mode based on the positioning information.

In some examples, the multiplexing mode includes a spatial division multiplexing mode, a frequency division multiplexing mode, a time division multiplexing mode, or a combination thereof.

In some examples, to support monitoring the one or more network conditions and the parameters, the capability component 865 is capable of, configured to, or operable to support a means for monitoring for capability and resource information of the at least one distributed unit, the set of multiple radio units, or any combination thereof.

In some examples, the capability and resource information includes a quantity of antenna panels, a power value associated with each antenna panel, a quantity of supported layers, an indication of available beams and beam bandwidths, or any combination thereof.

In some examples, the one or more fronthaul operation parameters include panel assignments for the at least one radio unit, beamforming weights for the at least one radio unit, or any combination thereof. Additionally, or alternatively, the one or more fronthaul operation parameters include Layer 1 parameters of the fronthaul network, Layer 2 parameters of the fronthaul network, or any combination thereof.

In some examples, the network entity includes a fronthaul network controller associated with a near-real time radio access network (RAN) intelligent controller or a non-real time RAN intelligent controller.

Additionally, or alternatively, the communications manager 820 may support wireless communication at a distributed unit in accordance with examples as disclosed herein. The network condition manager 835 is capable of, configured to, or operable to support a means for outputting one or more network conditions and parameters of a network, the network including a fronthaul network and a radio access network, where the fronthaul network includes at least the distributed unit that supports wireless communications for a set of multiple radio units via a set of multiple fronthaul communication links, and the radio access network includes the set of multiple radio units supporting communications for a set of multiple wireless devices. The operation parameter manager 840 is capable of, configured to, or operable to support a means for obtaining, based on outputting the one or more network conditions and the parameters, one or more fronthaul operation parameters to support wireless communications for at least one radio unit of the set of multiple radio units via one or more respective fronthaul communication links of the set of multiple fronthaul communication links.

In some examples, the parameter forwarding component 870 is capable of, configured to, or operable to support a means for outputting, to the at least one radio unit, at least a portion of the one or more fronthaul operation parameters based on obtaining the one or more fronthaul operation parameters.

In some examples, to support outputting the one or more network conditions and the parameters, the resource manager 875 is capable of, configured to, or operable to support a means for outputting an indication of available resources at the distributed unit, where obtaining the one or more fronthaul operation parameters is based on outputting the indication of the available resources.

In some examples, the one or more network conditions and the parameters include a traffic load of the radio access network, a delay budget associated with the set of multiple wireless devices supported by the set of multiple radio units, an activation status of the at least one radio unit, or a combination thereof.

In some examples, the one or more fronthaul operation parameters include a quantity of antenna panels per fronthaul communication link of the set of multiple fronthaul communication links, a transit power for each antenna panel, a quantity of resources assigned to each fronthaul communication link of the set of multiple fronthaul communication links, or any combination thereof, and obtaining the one or more fronthaul operation parameters is based on a change in the traffic load exceeding a threshold value.

In some examples, the traffic manager 895 is capable of, configured to, or operable to support a means for obtaining, based on an increase in the traffic load exceeding a threshold value, a message indicating the distributed unit to activate one or more carrier components associated with the set of multiple fronthaul communication links, one or more serving antenna panels associated with the set of multiple fronthaul communication links, or a combination thereof.

In some examples, the multiplexing mode manager 880 is capable of, configured to, or operable to support a means for obtaining, based on outputting the one or more network conditions and the parameters, a multiplexing mode for the distributed unit.

In some examples, the positioning manager 815 is capable of, configured to, or operable to support a means for outputting positioning information associated with the set of multiple radio units, where multiplexing mode is based on the positioning information. In some examples, the multiplexing mode manager 880 is capable of, configured to, or operable to support a means for applying the multiplexing mode to the one or more respective fronthaul communication links of the set of multiple fronthaul communication links to support wireless communications with the at least one radio unit.

In some examples, the multiplexing mode includes a spatial division multiplexing mode, a frequency division multiplexing mode, a time division multiplexing mode, or a combination thereof.

In some examples, to support outputting the one or more network conditions and the parameters, the capability manager 885 is capable of, configured to, or operable to support a means for outputting capability and resource information of the distributed unit, the set of multiple radio units, or any combination thereof.

In some examples, the capability and resource information includes a quantity of antenna panels, a power value associated with each antenna panel, a quantity of supported layers, an indication of available beams and beam bandwidths, or any combination thereof.

In some examples, the one or more fronthaul operation parameters include panel assignments for the at least one radio unit, beamforming weights for the at least one radio unit, or any combination thereof. Additionally, or alternatively, the one or more fronthaul operation parameters include Layer 1 parameters of the fronthaul network, Layer 2 parameters of the fronthaul network, or any combination thereof.

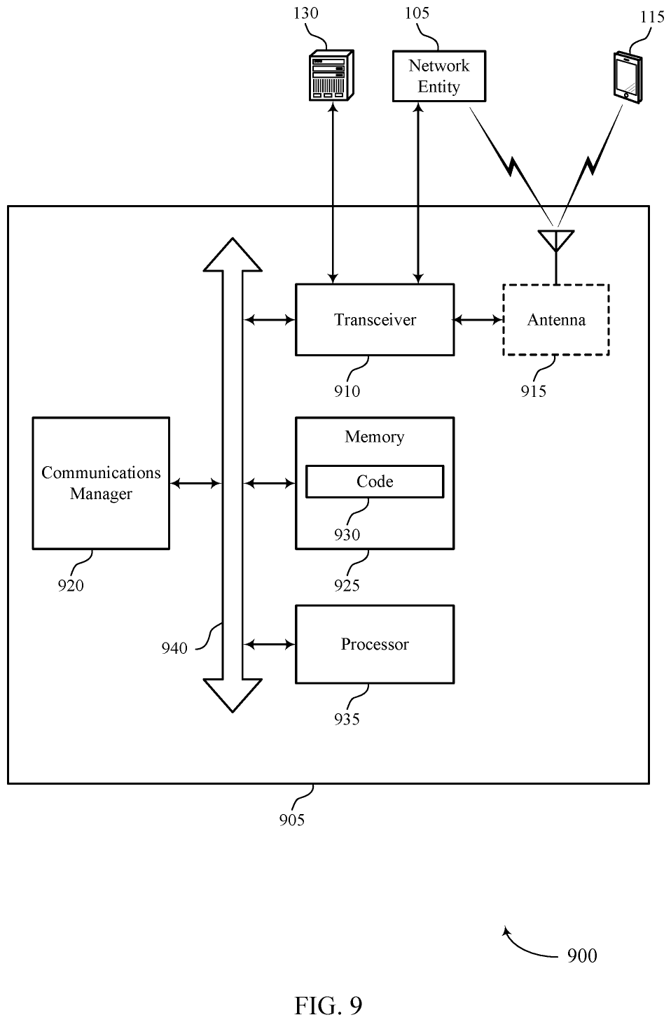

FIG. 9 shows a diagram of a system 900 including a device 905 that supports management of wireless fronthaul links in accordance with one or more aspects of the present disclosure. The device 905 may be an example of or include the components of a device 605, a device 705, or a network entity 105 as described herein. The device 905 may communicate with one or more network entities 105, one or more UEs 115, or any combination thereof, which may include communications over one or more wired interfaces, over one or more wireless interfaces, or any combination thereof. The device 905 may include components that support outputting and obtaining communications, such as a communications manager 920, a transceiver 910, an antenna 915, a memory 925, code 930, and a processor 935. These components may be in electronic communication or otherwise coupled (e.g., operatively, communicatively, functionally, electronically, electrically) via one or more buses (e.g., a bus 940).

The transceiver 910 may support bi-directional communications via wired links, wireless links, or both as described herein. In some examples, the transceiver 910 may include a wired transceiver and may communicate bi-directionally with another wired transceiver. Additionally, or alternatively, in some examples, the transceiver 910 may include a wireless transceiver and may communicate bi-directionally with another wireless transceiver. In some examples, the device 905 may include one or more antennas 915, which may be capable of transmitting or receiving wireless transmissions (e.g., concurrently). The transceiver 910 may also include a modem to modulate signals, to provide the modulated signals for transmission (e.g., by one or more antennas 915, by a wired transmitter), to receive modulated signals (e.g., from one or more antennas 915, from a wired receiver), and to demodulate signals. In some implementations, the transceiver 910 may include one or more interfaces, such as one or more interfaces coupled with the one or more antennas 915 that are configured to support various receiving or obtaining operations, or one or more interfaces coupled with the one or more antennas 915 that are configured to support various transmitting or outputting operations, or a combination thereof. In some implementations, the transceiver 910 may include or be configured for coupling with one or more processors or memory components that are operable to perform or support operations based on received or obtained information or signals, or to generate information or other signals for transmission or other outputting, or any combination thereof. In some implementations, the transceiver 910, or the transceiver 910 and the one or more antennas 915, or the transceiver 910 and the one or more antennas 915 and one or more processors or memory components (for example, the processor 935, or the memory 925, or both), may be included in a chip or chip assembly that is installed in the device 905. In some examples, the transceiver may be operable to support communications via one or more communications links (e.g., a communication link 125, a backhaul communication link 120, a midhaul communication link 162, a fronthaul communication link 168).

The memory 925 may include RAM and ROM. The memory 925 may store computer-readable, computer-executable code 930 including instructions that, when executed by the processor 935, cause the device 905 to perform various functions described herein. The code 930 may be stored in a non-transitory computer-readable medium such as system memory or another type of memory. In some cases, the code 930 may not be directly executable by the processor 935 but may cause a computer (e.g., when compiled and executed) to perform functions described herein. In some cases, the memory 925 may contain, among other things, a BIOS which may control basic hardware or software operation such as the interaction with peripheral components or devices.

The processor 935 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 935 may be configured to operate a memory array using a memory controller. In some other cases, a memory controller may be integrated into the processor 935. The processor 935 may be configured to execute computer-readable instructions stored in a memory (e.g., the memory 925) to cause the device 905 to perform various functions (e.g., functions or tasks supporting management of wireless fronthaul links). For example, the device 905 or a component of the device 905 may include a processor 935 and memory 925 coupled with the processor 935, the processor 935 and memory 925 configured to perform various functions described herein. The processor 935 may be an example of a cloud-computing platform (e.g., one or more physical nodes and supporting software such as operating systems, virtual machines, or container instances) that may host the functions (e.g., by executing code 930) to perform the functions of the device 905. The processor 935 may be any one or more suitable processors capable of executing scripts or instructions of one or more software programs stored in the device 905 (such as within the memory 925). In some implementations, the processor 935 may be a component of a processing system. A processing system may generally refer to a system or series of machines or components that receives inputs and processes the inputs to produce a set of outputs (which may be passed to other systems or components of, for example, the device 905). For example, a processing system of the device 905 may refer to a system including the various other components or subcomponents of the device 905, such as the processor 935, or the transceiver 910, or the communications manager 920, or other components or combinations of components of the device 905. The processing system of the device 905 may interface with other components of the device 905, and may process information received from other components (such as inputs or signals) or output information to other components. For example, a chip or modem of the device 905 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 905 may transmit information output from the chip or modem. Additionally, or alternatively, in some implementations, the one or more interfaces may refer to an interface between the processing system of the chip or modem and a receiver, such that the device 905 may obtain information or signal inputs, and the information may be passed to the processing system. A person having ordinary skill in the art will readily recognize that a first interface also may obtain information or signal inputs, and a second interface also may output information or signal outputs.

In some examples, a bus 940 may support communications of (e.g., within) a protocol layer of a protocol stack. In some examples, a bus 940 may support communications associated with a logical channel of a protocol stack (e.g., between protocol layers of a protocol stack), which may include communications performed within a component of the device 905, or between different components of the device 905 that may be co-located or located in different locations (e.g., where the device 905 may refer to a system in which one or more of the communications manager 920, the transceiver 910, the memory 925, the code 930, and the processor 935 may be located in one of the different components or divided between different components).

In some examples, the communications manager 920 may manage aspects of communications with a core network 130 (e.g., via one or more wired or wireless backhaul links). For example, the communications manager 920 may manage the transfer of data communications for client devices, such as one or more UEs 115. In some examples, the communications manager 920 may manage communications with other network entities 105, and may include a controller or scheduler for controlling communications with UEs 115 in cooperation with other network entities 105. In some examples, the communications manager 920 may support an X2 interface within an LTE/LTE-A wireless communications network technology to provide communication between network entities 105.

The communications manager 920 may support wireless communications at a network entity in accordance with examples as disclosed herein. For example, the communications manager 920 is capable of, configured to, or operable to support a means for monitoring one or more network conditions and parameters of a network, the network including a fronthaul network and a radio access network, where the fronthaul network includes at least one distributed unit supporting wireless communications for a set of multiple radio units via a set of multiple fronthaul communication links, and the radio access network includes the set of multiple radio units supporting communications for a set of multiple wireless devices. The communications manager 920 is capable of, configured to, or operable to support a means for outputting, based at least in part on the one or more network conditions and the parameters, one or more fronthaul operation parameters for the at least one distributed unit to support wireless communications for at least one radio unit of the set of multiple radio units via one or more respective fronthaul communication links of the set of multiple fronthaul communication links.

Additionally, or alternatively, the communications manager 920 may support wireless communication at a distributed unit in accordance with examples as disclosed herein. For example, the communications manager 920 is capable of, configured to, or operable to support a means for outputting one or more network conditions and parameters of a network, the network including a fronthaul network and a radio access network, where the fronthaul network includes at least the distributed unit that supports wireless communications for a set of multiple radio units via a set of multiple fronthaul communication links, and the radio access network includes the set of multiple radio units supporting communications for a set of multiple wireless devices. The communications manager 920 is capable of, configured to, or operable to support a means for obtaining, based at least in part on outputting the one or more network conditions and the parameters, one or more fronthaul operation parameters to support wireless communications for at least one radio unit of the set of multiple radio units via one or more respective fronthaul communication links of the set of multiple fronthaul communication links.

By including or configuring the communications manager 920 in accordance with examples as described herein, the device 905 may support techniques for managing a fronthaul network with reduced processing and power consumption, providing for an improved utilization of processing capability.

In some examples, the communications manager 920 may be configured to perform various operations (e.g., receiving, obtaining, monitoring, outputting, transmitting) using or otherwise in cooperation with the transceiver 910, the one or more antennas 915 (e.g., where applicable), or any combination thereof. Although the communications manager 920 is illustrated as a separate component, in some examples, one or more functions described with reference to the communications manager 920 may be supported by or performed by the transceiver 910, the processor 935, the memory 925, the code 930, or any combination thereof. For example, the code 930 may include instructions executable by the processor 935 to cause the device 905 to perform various aspects of management of wireless fronthaul links as described herein, or the processor 935 and the memory 925 may be otherwise configured to perform or support such operations.

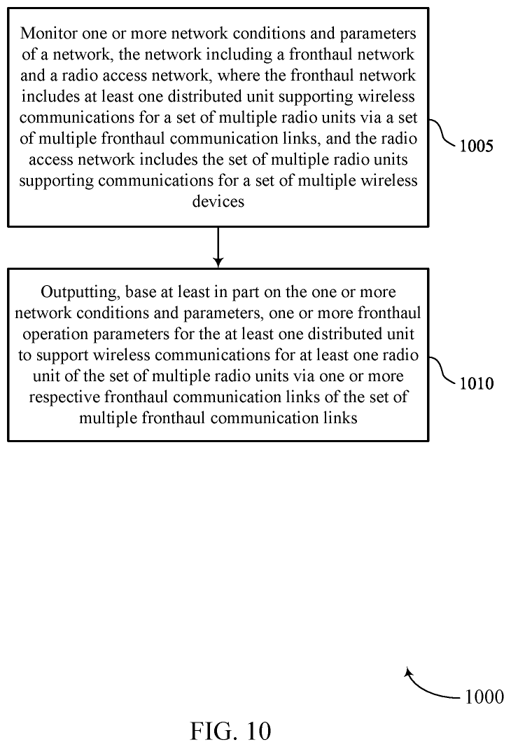

FIG. 10 shows a flowchart illustrating a method 1000 that supports management of wireless fronthaul links in accordance with aspects of the present disclosure. The operations of the method 1000 may be implemented by a network entity or its components as described herein. For example, the operations of the method 1000 may be performed by a network entity as described with reference to FIGS. 1 through 9. In some examples, a network entity may execute a set of instructions to control the functional elements of the wireless network entity to perform the described functions. Additionally, or alternatively, the wireless network entity may perform aspects of the described functions using special-purpose hardware.

At 1005, the method may include monitoring one or more network conditions and parameters of a network, the network including a fronthaul network and a radio access network, where the fronthaul network includes at least one distributed unit supporting wireless communications for a set of multiple radio units via a set of multiple fronthaul communication links, and the radio access network includes the set of multiple radio units supporting communications for a set of multiple wireless devices. The operations of 1005 may be performed in accordance with examples as disclosed herein. In some examples, aspects of the operations of 1005 may be performed by a network condition component 825 as described with reference to FIG. 8.

At 1010, the method may include outputting, based on the one or more network conditions and the parameters, one or more fronthaul operation parameters for the at least one distributed unit to support wireless communications for at least one radio unit of the set of multiple radio units via one or more respective fronthaul communication links of the set of multiple fronthaul communication links. The operations of 1010 may be performed in accordance with examples as disclosed herein. In some examples, aspects of the operations of 1010 may be performed by an operation parameter component 830 as described with reference to FIG. 8.

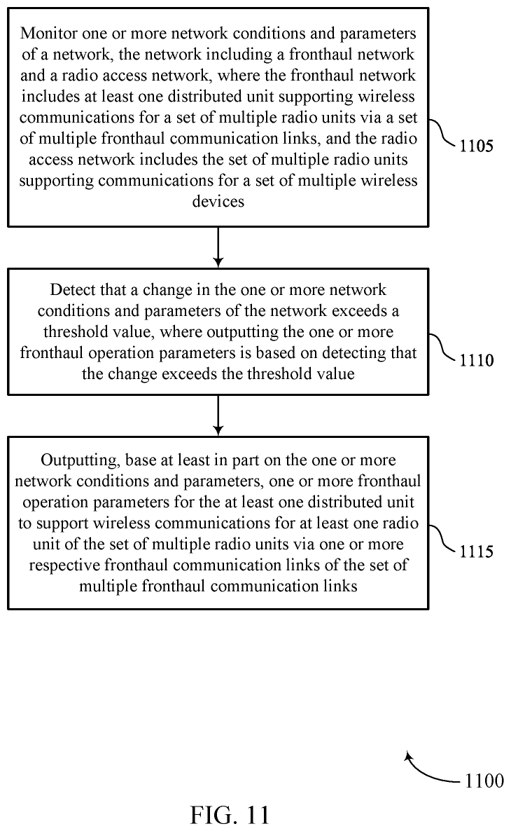

FIG. 11 shows a flowchart illustrating a method 1100 that supports management of wireless fronthaul links in accordance with aspects of the present disclosure. The operations of the method 1100 may be implemented by a network entity or its components as described herein. For example, the operations of the method 1100 may be performed by a network entity as described with reference to FIGS. 1 through 9. In some examples, a network entity may execute a set of instructions to control the functional elements of the wireless network entity to perform the described functions. Additionally, or alternatively, the wireless network entity may perform aspects of the described functions using special-purpose hardware.

At 1105, the method may include monitoring one or more network conditions and parameters of a network, the network including a fronthaul network and a radio access network, where the fronthaul network includes at least one distributed unit supporting wireless communications for a set of multiple radio units via a set of multiple fronthaul communication links, and the radio access network includes the set of multiple radio units supporting communications for a set of multiple wireless devices. The operations of 1105 may be performed in accordance with examples as disclosed herein. In some examples, aspects of the operations of 1105 may be performed by a network condition component 825 as described with reference to FIG. 8.

At 1110, the method may include detecting that a change in the one or more network conditions and the parameters of the network exceeds a threshold value, where outputting the one or more fronthaul operation parameters is based on detecting that the change exceeds the threshold value. The operations of 1110 may be performed in accordance with examples as disclosed herein. In some examples, aspects of the operations of 1110 may be performed by a change monitoring component 845 as described with reference to FIG. 8.

At 1115, the method may include outputting, based on the one or more network conditions and the parameters, one or more fronthaul operation parameters for the at least one distributed unit to support wireless communications for at least one radio unit of the set of multiple radio units via one or more respective fronthaul communication links of the set of multiple fronthaul communication links. The operations of 1115 may be performed in accordance with examples as disclosed herein. In some examples, aspects of the operations of 1115 may be performed by an operation parameter component 830 as described with reference to FIG. 8.

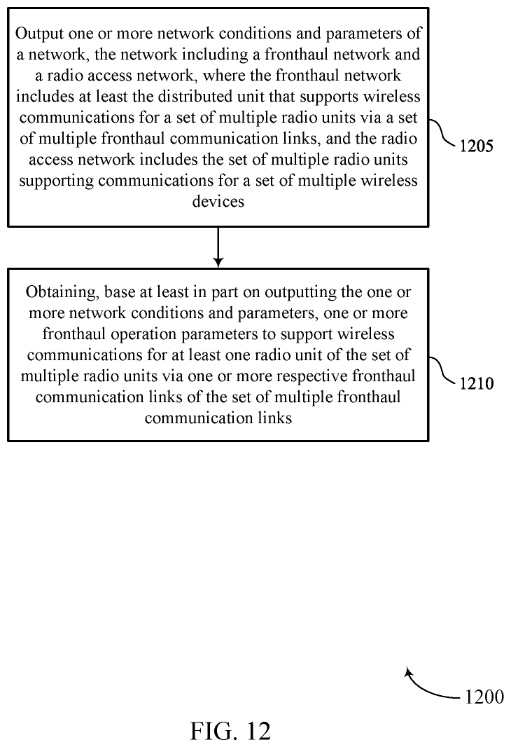

FIG. 12 shows a flowchart illustrating a method 1200 that supports management of wireless fronthaul links in accordance with aspects of the present disclosure. The operations of the method 1200 may be implemented by a network entity or its components as described herein. For example, the operations of the method 1200 may be performed by a network entity as described with reference to FIGS. 1 through 9. In some examples, a network entity may execute a set of instructions to control the functional elements of the wireless network entity to perform the described functions. Additionally, or alternatively, the wireless network entity may perform aspects of the described functions using special-purpose hardware.

At 1205, the method may include outputting one or more network conditions and parameters of a network, the network including a fronthaul network and a radio access network, where the fronthaul network includes at least the distributed unit that supports wireless communications for a set of multiple radio units via a set of multiple fronthaul communication links, and the radio access network includes the set of multiple radio units supporting communications for a set of multiple wireless devices. The operations of 1205 may be performed in accordance with examples as disclosed herein. In some examples, aspects of the operations of 1205 may be performed by a network condition manager 835 as described with reference to FIG. 8.

At 1210, the method may include obtaining, based on outputting the one or more network conditions and the parameters, one or more fronthaul operation parameters to support wireless communications for at least one radio unit of the set of multiple radio units via one or more respective fronthaul communication links of the set of multiple fronthaul communication links. The operations of 1210 may be performed in accordance with examples as disclosed herein. In some examples, aspects of the operations of 1210 may be performed by an operation parameter manager 840 as described with reference to FIG. 8.

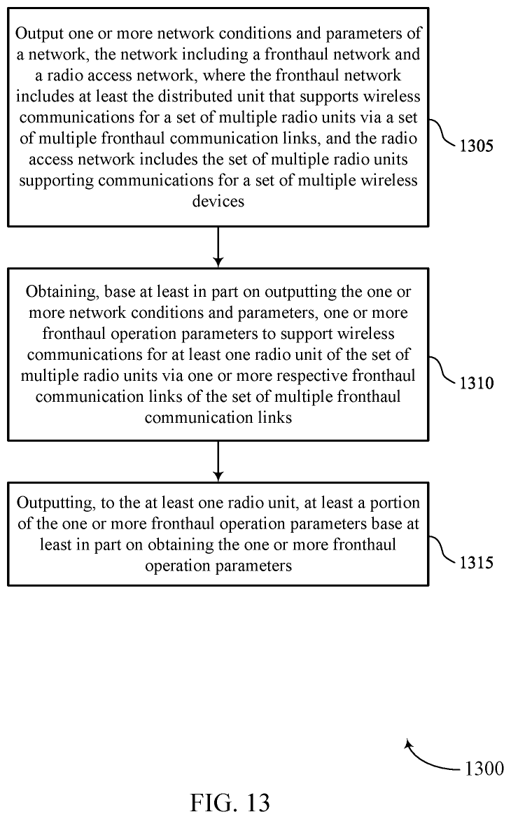

FIG. 13 shows a flowchart illustrating a method 1300 that supports management of wireless fronthaul links in accordance with aspects of the present disclosure. The operations of the method 1300 may be implemented by a network entity or its components as described herein. For example, the operations of the method 1300 may be performed by a network entity as described with reference to FIGS. 1 through 9. In some examples, a network entity may execute a set of instructions to control the functional elements of the wireless network entity to perform the described functions. Additionally, or alternatively, the wireless network entity may perform aspects of the described functions using special-purpose hardware.

At 1305, the method may include outputting one or more network conditions and parameters of a network, the network including a fronthaul network and a radio access network, where the fronthaul network includes at least the distributed unit that supports wireless communications for a set of multiple radio units via a set of multiple fronthaul communication links, and the radio access network includes the set of multiple radio units supporting communications for a set of multiple wireless devices. The operations of 1305 may be performed in accordance with examples as disclosed herein. In some examples, aspects of the operations of 1305 may be performed by a network condition manager 835 as described with reference to FIG. 8.

At 1310, the method may include obtaining, based on outputting the one or more network conditions and the parameters, one or more fronthaul operation parameters to support wireless communications for at least one radio unit of the set of multiple radio units via one or more respective fronthaul communication links of the set of multiple fronthaul communication links. The operations of 1310 may be performed in accordance with examples as disclosed herein. In some examples, aspects of the operations of 1310 may be performed by an operation parameter manager 840 as described with reference to FIG. 8.

At 1315, the method may include outputting, to the at least one radio unit, at least a portion of the one or more fronthaul operation parameters based on obtaining the one or more fronthaul operation parameters. The operations of 1315 may be performed in accordance with examples as disclosed herein. In some examples, aspects of the operations of 1315 may be performed by a parameter forwarding component 870 as described with reference to FIG. 8.

The following provides an overview of aspects of the present disclosure:
Aspect 1: A method for wireless communications at a network entity, comprising: monitoring one or more network conditions and parameters of a network, the network comprising a fronthaul network and a radio access network, wherein the fronthaul network comprises at least one DU supporting wireless communications for a plurality of RUs via a plurality of fronthaul communication links, and the radio access network comprises the plurality of RUs supporting communications for a plurality of wireless devices; and outputting, based at least in part on the one or more network conditions and the parameters, one or more fronthaul operation parameters for the at least one DU to support wireless communications for at least one RU of the plurality of RUs via one or more respective fronthaul communication links of the plurality of fronthaul communication links.
Aspect 2: The method of aspect 1, further comprising: detecting that a change in the one or more network conditions and the parameters of the network exceeds a threshold value, wherein outputting the one or more fronthaul operation parameters is based at least in part on detecting that the change exceeds the threshold value.
Aspect 3: The method of any of aspects 1 through 2, further comprising: obtaining an indication of available resources at the at least one DU, wherein the one or more fronthaul operation parameters are based at least in part on the available resources.
Aspect 4: The method of any of aspects 1 through 3, wherein monitoring the one or more network conditions and the parameters comprises: monitoring a traffic load of the radio access network, a delay budget associated with the plurality of wireless devices supported by the plurality of RUs, an activation status of the at least one RU, or a combination thereof.
Aspect 5: The method of aspect 4, further comprising: detecting that a change in the traffic load exceeds a threshold value, wherein the one or more fronthaul operation parameters are based at least in part on the change in the traffic load exceeding the threshold value, and the one or more fronthaul operation parameters comprise a quantity of antenna panels per fronthaul communication link of the plurality of fronthaul communication links, a transmit power for each antenna panel, a quantity of resources assigned to each fronthaul communication link of the plurality of fronthaul communication links, or any combination thereof.
Aspect 6: The method of any of aspects 4 through 5, further comprising: detecting that an increase in the traffic load exceeds a threshold value; and outputting, based at least in part on detecting that the increase in the traffic load exceeds the threshold value, a message indicating the at least one DU to activate one or more carrier components associated with the plurality of fronthaul communication links, one or more serving antenna panels associated with the plurality of fronthaul communication links, or a combination thereof.
Aspect 7: The method of any of aspects 1 through 6, wherein outputting the one or more fronthaul operation parameters comprises: outputting a multiplexing mode for the at least one DU, wherein the multiplexing mode is based at least in part on the one or more network conditions and the parameters of the network.
Aspect 8: The method of aspect 7, further comprising: obtaining positioning information associated with the plurality of RUs, wherein the one or more network conditions and the parameters comprises the positioning information of the plurality of RUs; and selecting the multiplexing mode based at least in part on the positioning information.
Aspect 9: The method of any of aspects 7 through 8, wherein the multiplexing mode comprises a spatial division multiplexing mode, a frequency division multiplexing mode, a time division multiplexing mode, or a combination thereof.
Aspect 10: The method of any of aspects 1 through 9, wherein monitoring the one or more network conditions and the parameters further comprises: monitoring for capability and resource information of the at least one DU, the plurality of RUs, or any combination thereof.
Aspect 11: The method of aspect 10, wherein the capability and resource information comprises a quantity of antenna panels, a power value associated with each antenna panel, a quantity of supported layers, an indication of available beams and beam bandwidths, or any combination thereof.
Aspect 12: The method of any of aspects 1 through 11, wherein the one or more fronthaul operation parameters comprise panel assignments for the at least one RU, beamforming weights for the at least one RU, or any combination thereof.
Aspect 13: The method of any of aspects 1 through 12, wherein the one or more fronthaul operation parameters comprise Layer 1 parameters of the fronthaul network, Layer 2 parameters of the fronthaul network, or any combination thereof.
Aspect 14: The method of any of aspects 1 through 13, wherein the network entity comprises an FNC associated with a near-real time radio access network (RAN) intelligent controller or a non-real time RAN intelligent controller.
Aspect 15: A method for wireless communication at a DU, comprising: outputting one or more network conditions and parameters of a network, the network comprising a fronthaul network and a radio access network, wherein the fronthaul network comprises at least the DU that supports wireless communications for a plurality of RUs via a plurality of fronthaul communication links, and the radio access network comprises the plurality of RUs supporting communications for a plurality of wireless devices; and obtaining, based at least in part on outputting the one or more network conditions and the parameters, one or more fronthaul operation parameters to support wireless communications for at least one RU of the plurality of RUs via one or more respective fronthaul communication links of the plurality of fronthaul communication links.
Aspect 16: The method of aspect 15, further comprising: outputting, to the at least one RU, at least a portion of the one or more fronthaul operation parameters based at least in part on obtaining the one or more fronthaul operation parameters.
Aspect 17: The method of any of aspects 15 through 16, wherein outputting the one or more network conditions and the parameters further comprises: outputting an indication of available resources at the DU, wherein obtaining the one or more fronthaul operation parameters is based at least in part on outputting the indication of the available resources.
Aspect 18: The method of any of aspects 15 through 17, wherein the one or more network conditions and the parameters comprise a traffic load of the radio access network, a delay budget associated with the plurality of wireless devices supported by the plurality of RUs, an activation status of the at least one RU, or a combination thereof.
Aspect 19: The method of aspect 18, wherein the one or more fronthaul operation parameters comprise a quantity of antenna panels per fronthaul communication link of the plurality of fronthaul communication links, a transit power for each antenna panel, a quantity of resources assigned to each fronthaul communication link of the plurality of fronthaul communication links, or any combination thereof, and obtaining the one or more fronthaul operation parameters is based at least in part on a change in the traffic load exceeding a threshold value.
Aspect 20: The method of any of aspects 18 through 19, further comprising: obtaining, based at least in part on an increase in the traffic load exceeding a threshold value, a message indicating the DU to activate one or more carrier components associated with the plurality of fronthaul communication links, one or more serving antenna panels associated with the plurality of fronthaul communication links, or a combination thereof.
Aspect 21: The method of any of aspects 15 through 20, further comprising: obtaining, based at least in part on outputting the one or more network conditions and the parameters, a multiplexing mode for the DU.
Aspect 22: The method of aspect 21, further comprising: outputting positioning information associated with the plurality of RUs, wherein multiplexing mode is based at least in part on the positioning information; and applying the multiplexing mode to the one or more respective fronthaul communication links of the plurality of fronthaul communication links to support wireless communications with the at least one RU.
Aspect 23: The method of any of aspects 21 through 22, wherein the multiplexing mode comprises a spatial division multiplexing mode, a frequency division multiplexing mode, a time division multiplexing mode, or a combination thereof.
Aspect 24: The method of any of aspects 15 through 23, wherein outputting the one or more network conditions and the parameters further comprises: outputting capability and resource information of the DU, the plurality of RUs, or any combination thereof.
Aspect 25: The method of aspect 24, wherein the capability and resource information comprises a quantity of antenna panels, a power value associated with each antenna panel, a quantity of supported layers, an indication of available beams and beam bandwidths, or any combination thereof.
Aspect 26: The method of any of aspects 15 through 25, wherein the one or more fronthaul operation parameters comprise panel assignments for the at least one RU, beamforming weights for the at least one RU, or any combination thereof.
Aspect 27: The method of any of aspects 15 through 26, wherein the one or more fronthaul operation parameters comprise Layer 1 parameters of the fronthaul network, Layer 2 parameters of the fronthaul network, or any combination thereof.
Aspect 28: An apparatus for wireless communications at a network entity, comprising a processor; memory coupled with the processor; and instructions stored in the memory and executable by the processor to cause the apparatus to perform a method of any of aspects 1 through 14.
Aspect 29: An apparatus for wireless communications at a network entity, comprising at least one means for performing a method of any of aspects 1 through 14.
Aspect 30: A non-transitory computer-readable medium storing code for wireless communications at a network entity, the code comprising instructions executable by a processor to perform a method of any of aspects 1 through 14.
Aspect 31: An apparatus for wireless communication at a DU, comprising a processor; memory coupled with the processor; and instructions stored in the memory and executable by the processor to cause the apparatus to perform a method of any of aspects 15 through 27.
Aspect 32: An apparatus for wireless communication at a DU, comprising at least one means for performing a method of any of aspects 15 through 27.
Aspect 33: A non-transitory computer-readable medium storing code for wireless communication at a DU, the code comprising instructions executable by a processor to perform a method of any of aspects 15 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a network entity, comprising:
a memory; and
a processor coupled with the memory and configured to cause the apparatus to:
monitor one or more network conditions and parameters of a network, the network comprising a fronthaul network and a radio access network, wherein the fronthaul network comprises at least one distributed unit supporting wireless communications for a plurality of radio units via a plurality of fronthaul communication links, and the radio access network comprises the plurality of radio units supporting communications for a plurality of wireless devices; and
output, based at least in part on the one or more network conditions and the parameters, one or more fronthaul operation parameters for the at least one distributed unit to support wireless communications for at least one radio unit of the plurality of radio units via one or more respective fronthaul communication links of the plurality of fronthaul communication links.

2. The apparatus of claim 1, wherein the processor is further configured to cause the apparatus to:
detect that a change in the one or more network conditions and the parameters of the network exceeds a threshold value, wherein outputting the one or more fronthaul operation parameters is based at least in part on detecting that the change exceeds the threshold value.

3. The apparatus of claim 1, wherein the processor is further configured to cause the apparatus to:
obtain an indication of available resources at the at least one distributed unit, wherein the one or more fronthaul operation parameters are based at least in part on the available resources.

4. The apparatus of claim 1, wherein, to monitor the one or more network conditions and the parameters, the processor is further configured to cause the apparatus to:
monitor a traffic load of the radio access network, a delay budget associated with the plurality of wireless devices supported by the plurality of radio units, an activation status of the at least one radio unit, or a combination thereof.

5. The apparatus of claim 4, wherein the processor is further configured to cause the apparatus to:
detect that a change in the traffic load exceeds a threshold value, wherein the one or more fronthaul operation parameters are based at least in part on the change in the traffic load exceeding the threshold value, and the one or more fronthaul operation parameters comprise a quantity of antenna panels per fronthaul communication link of the plurality of fronthaul communication links, a transmit power for each antenna panel, a quantity of resources assigned to each fronthaul communication link of the plurality of fronthaul communication links, or any combination thereof.

6. The apparatus of claim 4, wherein the processor is further configured to cause the apparatus to:
detect that an increase in the traffic load exceeds a threshold value; and
output based at least in part on detecting that the increase in the traffic load exceeds the threshold value, a message indicating the at least one distributed unit to activate one or more carrier components associated with the plurality of fronthaul communication links, one or more serving antenna panels associated with the plurality of fronthaul communication links, or a combination thereof.

7. The apparatus of claim 1, wherein, to output the one or more fronthaul operation parameters, the processor is further configured to cause the apparatus to:
output a multiplexing mode for the at least one distributed unit, wherein the multiplexing mode is based at least in part on the one or more network conditions and the parameters of the network.

8. The apparatus of claim 7, wherein the processor is further configured to cause the apparatus to:
obtain positioning information associated with the plurality of radio units, wherein the one or more network conditions and the parameters comprises the positioning information of the plurality of radio units; and
select the multiplexing mode based at least in part on the positioning information.

9. The apparatus of claim 7, wherein the multiplexing mode comprises a spatial division multiplexing mode, a frequency division multiplexing mode, a time division multiplexing mode, or a combination thereof.

10. The apparatus of claim 1, wherein, to monitor the one or more network conditions and the parameters, the processor is further configured to cause the apparatus to:
monitor for capability and resource information of the at least one distributed unit, the plurality of radio units, or any combination thereof.

11. The apparatus of claim 10, wherein the capability and resource information comprises a quantity of antenna panels, a power value associated with each antenna panel, a quantity of supported layers, an indication of available beams and beam bandwidths, or any combination thereof.

12. The apparatus of claim 1, wherein the one or more fronthaul operation parameters comprise panel assignments for the at least one radio unit, beamforming weights for the at least one radio unit, or any combination thereof.

13. The apparatus of claim 1, wherein the one or more fronthaul operation parameters comprise Layer 1 parameters of the fronthaul network, Layer 2 parameters of the fronthaul network, or any combination thereof.

14. The apparatus of claim 1, wherein the network entity comprises a fronthaul network controller associated with a near-real time radio access network (RAN) intelligent controller or a non-real time RAN intelligent controller.

15. An apparatus for wireless communication at a distributed unit, comprising:
a memory; and
a processor coupled with the memory and configured to cause the apparatus to:
output one or more network conditions and parameters of a network, the network comprising a fronthaul network and a radio access network, wherein the fronthaul network comprises at least the distributed unit that supports wireless communications for a plurality of radio units via a plurality of fronthaul communication links, and the radio access network comprises the plurality of radio units supporting communications for a plurality of wireless devices; and
obtain, based at least in part on outputting the one or more network conditions and the parameters, one or more fronthaul operation parameters to support wireless communications for at least one radio unit of the plurality of radio units via one or more respective fronthaul communication links of the plurality of fronthaul communication links.

16. The apparatus of claim 15, wherein the processor is further configured to cause the apparatus to:
output, to the at least one radio unit, at least a portion of the one or more fronthaul operation parameters based at least in part on obtaining the one or more fronthaul operation parameters.

17. The apparatus of claim 15, wherein, to output the one or more network conditions and the parameters, the processor is further configured to cause the apparatus to:
output an indication of available resources at the distributed unit, wherein obtaining the one or more fronthaul operation parameters is based at least in part on outputting the indication of the available resources.

18. The apparatus of claim 15, wherein the one or more network conditions and the parameters comprise a traffic load of the radio access network, a delay budget associated with the plurality of wireless devices supported by the plurality of radio units, an activation status of the at least one radio unit, or a combination thereof.

19. The apparatus of claim 18, wherein the one or more fronthaul operation parameters comprise a quantity of antenna panels per fronthaul communication link of the plurality of fronthaul communication links, a transit power for each antenna panel, a quantity of resources assigned to each fronthaul communication link of the plurality of fronthaul communication links, or any combination thereof, and obtaining the one or more fronthaul operation parameters is based at least in part on a change in the traffic load exceeding a threshold value.

20. The apparatus of claim 18, wherein the processor is further configured to cause the apparatus to:
obtain, based at least in part on an increase in the traffic load exceeding a threshold value, a message indicating the distributed unit to activate one or more carrier components associated with the plurality of fronthaul communication links, one or more serving antenna panels associated with the plurality of fronthaul communication links, or a combination thereof.

21. The apparatus of claim 15, wherein the processor is further configured to cause the apparatus to:
obtain, based at least in part on outputting the one or more network conditions and the parameters, a multiplexing mode for the distributed unit.

22. The apparatus of claim 21, wherein the processor is further configured to cause the apparatus to:
output positioning information associated with the plurality of radio units, wherein multiplexing mode is based at least in part on the positioning information; and
apply the multiplexing mode to the one or more respective fronthaul communication links of the plurality of fronthaul communication links to support wireless communications with the at least one radio unit.

23. The apparatus of claim 21, wherein the multiplexing mode comprises a spatial division multiplexing mode, a frequency division multiplexing mode, a time division multiplexing mode, or a combination thereof.

24. The apparatus of claim 15, wherein, to output the one or more network conditions and the parameters, the processor is further configured to cause the apparatus to:
output capability and resource information of the distributed unit, the plurality of radio units, or any combination thereof.

25. The apparatus of claim 24, wherein the capability and resource information comprises a quantity of antenna panels, a power value associated with each antenna panel, a quantity of supported layers, an indication of available beams and beam bandwidths, or any combination thereof.

26. The apparatus of claim 15, wherein the one or more fronthaul operation parameters comprise panel assignments for the at least one radio unit, beamforming weights for the at least one radio unit, or any combination thereof.

27. The apparatus of claim 15, wherein the one or more fronthaul operation parameters comprise Layer 1 parameters of the fronthaul network, Layer 2 parameters of the fronthaul network, or any combination thereof.

28. A method for wireless communications at a network entity, comprising:
monitoring one or more network conditions and parameters of a network, the network comprising a fronthaul network and a radio access network, wherein the fronthaul network comprises at least one distributed unit supporting wireless communications for a plurality of radio units via a plurality of fronthaul communication links, and the radio access network comprises the plurality of radio units supporting communications for a plurality of wireless devices; and
outputting, based at least in part on the one or more network conditions and the parameters, one or more fronthaul operation parameters for the at least one distributed unit to support wireless communications for at least one radio unit of the plurality of radio units via one or more respective fronthaul communication links of the plurality of fronthaul communication links.

29. The method of claim 28, further comprising:
detecting that a change in the one or more network conditions and the parameters of the network exceeds a threshold value, wherein outputting the one or more fronthaul operation parameters is based at least in part on detecting that the change exceeds the threshold value.

30. A method for wireless communication at a distributed unit, comprising:
outputting one or more network conditions and parameters of a network, the network comprising a fronthaul network and a radio access network, wherein the fronthaul network comprises at least the distributed unit that supports wireless communications for a plurality of radio units via a plurality of fronthaul communication links, and the radio access network comprises the plurality of radio units supporting communications for a plurality of wireless devices; and
obtaining, based at least in part on outputting the one or more network conditions and the parameters, one or more fronthaul operation parameters to support wireless communications for at least one radio unit of the plurality of radio units via one or more respective fronthaul communication links of the plurality of fronthaul communication links.
